(19) United States
(12) Patent Application Publication
(10) Pub. No.: US 2005/0227024 A1
(43) Pub. Date: Oct. 13, 2005

(54) Image forming method and final medium to be transferred

(75) Inventor: Akihiro Shimomura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/101,578

(22) Filed: Apr. 8, 2005

(30) Foreign Application Priority Data
Apr. 9, 2004 (JP) P.2004-115095
Apr. 9, 2004 (JP) P.2004-115100

(51) Int. Cl. B41M 5/40

(52) U.S. Cl. 428/32.79

(57) ABSTRACT

An image forming method comprises: keeping a face of a final medium to be transferred towards a face of an intermediate transfer medium, wherein the final medium to be transferred comprises a transparent support having a readily adhesive layer, and the intermediate transfer medium has an image recorded on an image receiving layer; transferring the image onto the readily adhesive layer, so as to form a transferred image; and subjecting a surface of the readily adhesive layer having the transferred image to a smoothening treatment. And a final medium to be transferred for the image forming method comprises: a transparent support; and a readily adhesive layer provided on a surface of the transparent support onto which an image is to be transferred, wherein the readily adhesive layer has a surface roughness of from 0.5 to 7 μm in terms of Rz.

### BACKGROUND OF THE INVENTION

1. Field of the Invention

The present invention relates to an image forming method for forming an image which can be used for color proof (DDCP: direct digital color proof) in the printing field and to a transparent final medium to be transferred which is used for the subject method. In particular, the invention relates to a transparent final medium to be transferred and an image forming method in which an image having high adhesion strength and high image quality can be formed.

2. Description of the Invention

In the graphic art field, in general, for the purpose of checking errors in the color separation step before the regular printing (actual printing works), necessity of color correction, and the like, a color proof is prepared from a color separation film. In the recent pre-printing step (pre-press field), following the spread of an electronization system, there have been developed recording systems for preparing a color proof directly from a digital signal. According to such electronization systems, in general, halftone dot images of 150 lines or more per inch are reproduced, and the preparation of a color proof having high image quality is realized. In general, in order to record a proof having high image quality from a digital signal, laser beams which can be modulated by a digital signal and which can make the recorded light narrow are used as a recording head.

The image formation by the thermal transfer system utilizing laser beams enables one to achieve photographic printing with a high resolution, and there have hitherto been known the laser hot-melt system using a thermal transfer material comprising a support having thereon a light-to-heat conversion layer containing a light-to-heat conversion substance capable of absorbing laser beams to generate heat, an image forming layer containing a colorant, and optionally a thermal release layer, etc. (see, for example, JP-A-5-58045) and the laser abrasion system (see, for example, JP-A-6-219052). Further, recently, there is proposed the laser thin film transfer system as means for making the outlines of halftone dots clear and achieving high resolution and high image quality of a transferred image (see, for example, JP-A-2002-274051).

In the recent years, printing on various processed films (mainly plastic films) such as transparent films as a final medium to be transferred, such as printing for wrapping, is often carried out. In printing on transparent films such as plastic films, there are required clear images such that a non-image area thereof keeps high transparency, whereas an image area thereof has high grade and high image quality. However, in general, transparent films are less in surface irregularity and poor in adhesion of images as compared with so-called papers. Accordingly, there is demanded a method in which an image having high adhesion strength and high image quality can be formed on a transparent final medium to be transferred and high transparency is kept in a non-image area. In order to respond to this demand, there is proposed a method in which a readily adhesive layer is provided on a support of a final medium to be transferred, and an image is transferred onto the readily adhesive layer, thereby enhancing the adhesion strength of the image (see, for example, JP-A-2000-108512).

### SUMMARY OF THE INVENTION

According to the method described in the foregoing JP-A-2000-108512, it is possible to form an image having adhesive strength to some extent on the transparent final medium to be transferred. On the other hand, however, since the readily adhesive layer deteriorates slipperiness against the transfer medium, there is generated such a new problem that the generation of a wrinkle and the like occurs in transferring the image, thereby deteriorating the image quality.

In view of the foregoing backgrounds, a problem of the invention is to provide a transparent final medium to be transfer and an image forming method in which an image having high adhesion strength and high image quality can be formed.

The foregoing problem can be achieved by the following means.

(1) An image forming method comprises:
keeping a face of a final medium to be transferred towards a face of an intermediate transfer medium, wherein the final medium to be transferred comprises a transparent support having a readily adhesive layer, and the intermediate transfer medium has an image recorded on an image receiving layer;
transferring the image onto the readily adhesive layer, so as to form a transferred image; and
subjecting a surface of the readily adhesive layer having the transferred image to a smoothening treatment.

(2) An image forming method comprises:
keeping a face of a final medium to be transferred towards a face of an intermediate transfer medium, wherein the final medium to be transferred comprises a transparent support having a readily adhesive layer, and the intermediate transfer medium has an image recorded on an image receiving layer;
transferring the image onto the readily adhesive layer, so as to form a laminate comprising the transparent support, the readily adhesive layer, the image and the image receiving layer, in this order; and
subjecting a surface of the laminate to a smoothening treatment.

(3) The image forming method as described in (1) above,
wherein the readily adhesive layer is formed by transferring a readily adhesive layer from a readily adhesive layer-provided release paper onto the transparent support.

(4) The image forming method as described in (1) or (3) above,
wherein the final medium to be transferred has a release sheet on the readily adhesive layer, and the method further comprises peeling apart the release sheet from the readily adhesive layer prior to the transferring the image.

(5) The image forming method as described in (3) above,
wherein the transferring a readily adhesive layer onto the transparent support is carried out by heating and pressurizing a laminate comprising the transparent support and the readily adhesive layer-provided release paper.

(6) The image forming method as described in any of (1) and (3) to (5) above,
wherein the readily adhesive layer has a surface roughness of from 0.5 to 10 μm in terms of Rz.

(7) The image forming method as described in any of (1) and (3) to (5) above,
wherein the readily adhesive layer has a surface roughness of from 0.5 to 7 μm in terms of Rz.

(8) The image forming method as described in (1) and (3) to (7) above,
wherein a coefficient of a static friction between the readily adhesive layer and a surface of the intermediate transfer medium is not more than 1.3.

(9) The image forming method as described in (1) and (3) to (7) above,
wherein a coefficient of a static friction between the readily adhesive layer and a surface of the intermediate transfer medium is not more than 0.8.

(10) The image forming method as described in any of (1) and (3) to (9) above,
wherein the readily adhesive layer has a rigid pendulum attenuation factor at 23° C. of 0.02 or more.

(11) The image forming method as described in any of (1) and (3) to (10) above,
wherein the readily adhesive layer has a rigid pendulum attenuation factor at 90° C. of 0.1 or more.

(12) The image forming method as described in any of (1) and (3) to (11) above,
wherein the readily adhesive layer comprises mat particles having a mean particle size of from 0.5 to 20 μm.

(13) The image forming method as described in any of (1) and (3) to (12) above,
wherein the readily adhesive layer comprises at least one of a polyvinyl butyral resin, a polyurethane resin and an acrylic resin.

(14) The image forming method as described in any of (1) and (3) to (13) above,
wherein the readily adhesive layer has a Vicat softening point of not higher than 100° C.

(15) The image forming method as described in any of (1) and (3) to (14) above,
wherein the transferring the image onto the readily adhesive layer is carried out by heating and pressurizing a laminate comprising the final medium to be transferred and the intermediate transfer medium.

(16) The image forming method as described in any of (1) and (3) to (15) above,
wherein the smoothening treatment is carried out by heating and pressurizing a laminate comprising the transparent support, the readily adhesive layer having the transferred image and a cover sheet on the surface of the readily adhesive layer having the transferred image.

(17) The image forming method as described in (16) above,
wherein a coefficient of a static friction between a surface of the cover sheet and a surface of an image receiving material is not more than 0.5.

(18) The image forming method as described in (16) or (17) above,
wherein the cover sheet has a surface roughness of from 0.1 to 3.0 μm in terms of Rz.

(19) The image forming method as described in any of (1) and (3) to (18) above,
wherein a glossiness of the surface of the readily adhesive layer having the transferred image is increased by from 5 to 100% by the smoothening treatment.

(20) The image forming method as described in any of (1) and (3) to (19) above,
wherein the image is an image containing at least a white color.

(21) The image forming method as described in any of (1) and (3) to (20) above,
wherein the image is an image containing at least a metallically glossy color.

(22) The image forming method as described in any of (1) and (3) to (21) above,
wherein an image recording on the image receiving layer of the intermediate transfer medium is a thermal transfer recording.

(23) A final medium to be transferred for an image forming method comprises:
a transparent support; and
a readily adhesive layer provided on a surface of the transparent support onto which an image is to be transferred,
wherein the method comprises: keeping a face of the final medium to be transferred towards a face of an intermediate transfer medium having an image; and transferring the image onto the readily adhesive layer,
wherein the readily adhesive layer has a surface roughness of from 0.5 to 7 μm in terms of Rz.

(24) The final medium to be transferred as described in (23) above,
wherein a coefficient of a static friction between the readily adhesive layer and a surface of the intermediate transfer medium is not more than 0.8.

(25) The final medium to be transferred as described in (23) or (24) above,
wherein the readily adhesive layer has a rigid pendulum attenuation factor at 23° C. of 0.02 or more.

(26) The final medium to be transferred as described in any of (23) to (25) above,
wherein the readily adhesive layer comprises mat particles having a mean particle size of from 0.5 to 20 μm.

(27) The final medium to be transferred as described in any of (23) to (26) above,
wherein the readily adhesive layer comprises at least one of a polyvinyl butyral resin, a polyurethane resin and an acrylic resin.

(28) The final medium to be transferred as described in any of (23) to (27) above, further comprises a release sheet on the readily adhesive layer.

### BRIEF DESCRIPTION OF THE DRAWINGS

FIG. 1 shows an outline view to show an example of the embodiment of the invention;

FIG. 2 shows an outline view of the mechanism of image formation by thin film thermal transfer using laser; and

FIG. 3 shows a schematic view to show the respective steps of the image forming method of the invention as achieved in the Examples.

### DETAILED DESCRIPTION OF THE INVENTION

The invention will be hereunder described in detail.

In the image forming method of the invention, a final medium to be transferred comprising a transparent support having thereon a readily adhesive layer and an intermediate transfer medium having an image recorded on an image receiving layer are opposed to each other, thereby transferring the image onto the readily adhesive layer. The image of the intermediate transfer medium may be transferred together with the image receiving layer onto the final medium to be transferred. In that case, on the final medium to be transferred, the image receiving layer covers the image and protects it.

In the final medium to be transferred of the invention, since the readily adhesive layer is previously provided, the adhesion strength of the transferred image and image receiving layer to the final medium to be transferred is enhanced so that when folded or scratched, peeling of the image is prevented from occurring.

It is preferable that the readily adhesive layer of the final medium to be transferred is formed by transferring the readily adhesive layer onto the transparent support from readily adhesive layer-provided release paper (one having a readily adhesive layer on release paper). It is preferable that this readily adhesive layer is formed just before the image formation. By forming the readily adhesive layer just before the image formation, it is not necessary to preserve the final medium to be transferred in the readily adhesive layer-provided state, and problems such as the generation of blocking can be avoided.

The transfer of the readily adhesive layer onto the transparent support from the readily adhesive layer-provided release paper can be carried out by superimposing the readily adhesive layer-provided release paper and the transparent support and heating them under pressure. The heating under pressure can be achieved by using a usual thermal transfer device. For example, it is possible to transfer the readily adhesive layer onto the transparent support by passing a laminate resulting from superimposing the readily layer-provided release paper and the transparent support through a pair of heat rollers and heating the laminate under pressure. During this, it is preferred to cover the upper and lower sides of the laminate by a cover sheet, place the laminate on a guide plate such as an aluminum plate and pass it between the heat rollers. By using the guide plate and the cover sheet, the generation of a wrinkle and the like and dimensional change are suppressed, whereby the transfer can be achieved well.

The heating temperature is preferably from 90 to 160° C., and more preferably from 110 to 140° C. The pressurizing pressure is preferably from 1 to 100 N/cm, and more preferably from 2 to 10 N/cm.

It is preferable that the readily adhesive layer on the transparent support of the final medium to be transferred has the following physical properties (a) to (f).
(a) A surface roughness is preferably from 0.5 to 10 μm, and more preferably from 3 to 7 μm in terms of Rz. When Rz of the surface of the readily adhesive layer falls within the foregoing range, during transferring the image onto the readily adhesive layer, the generation of a wrinkle is suppressed, and an image having high image quality, which is free from uneven gloss and deformation can be obtained, and therefore, such is preferable. Also, since the surface irregularity wherein Rz falls within the foregoing range is an irregularity which can be thoroughly smoothened by the sequent smoothening treatment, the transparency of a non-image area of the readily adhesive layer can be enhanced by the smoothening treatment, and therefore, such is preferable, too.

Since the surface irregularity of the readily adhesive layer of the final medium to be transferred is strongly reflected by a surface irregularity of the release paper itself of the readily adhesive layer-provided release paper, it can be adjusted by the surface irregularity of the release paper.

The surface roughness Rz refers to a ten-point average roughness corresponding to Rz (maximum height) defined by JIS and is one obtained by defining an average surface of a portion resulting from eliminating a standard area part from the curved surface as a standard level and inputting and converting a distance between the average value of the height of the five highest peaks and the average value of the depth of the five lowest valleys. For the measurement, a probe system three-dimensional roughness meter (SURFCOM 570A-3DF) manufactured by Tokyo Seimitsu Co., Ltd. can be used. For example, the measurement condition can be set up such that the measurement direction is the longitudinal direction, the cutoff value is 0.08 mm, the measurement area is 0.6 mm×0.4 mm, the feed pitch is 0.005 mm, and the measurement speed is 0.12 mm/s.
(b) A coefficient of static friction against the image-recorded image receiving layer to be transferred (image surface or surface of an image receiving layer in a portion where an image is not recorded) is preferably not more than 1.3, more preferably not more than 0.7 and further more preferably from 0.2 to 0.5. When the coefficient of static friction falls within the foregoing range, the final medium to be transferred and the intermediate transfer medium can be brought into smooth contact with each other; the generation of a wrinkle during transferring an image can be suppressed; and an image having high image quality, which is free from uneven gloss and deformation, can be obtained. Therefore, such is preferable.

The coefficient of static friction can be adjusted according to selection of raw materials of the readily adhesive layer, the transfer condition at the time of transfer from the readily adhesive layer-provided release paper, and so on.
(c) A rigid pendulum attenuation factor at 23° C. is preferably 0.02 or more, and more preferably from 0.05 to 0.2. The rigid pendulum attenuation factor at 23° C. is an index to exhibit softness of the readily adhesive layer, especially easiness of viscoelastic absorption of deformation energy. When this value is 0.02 or more, the adhesion strength to the transferred image is enhanced, and therefore, such is preferable.
(d) A rigid pendulum attenuation factor at 90° C. is preferably 0.1 or more, and more preferably from 0.15 to 0.5. The rigid pendulum attenuation factor at 90° C. is an index to exhibit easiness of deformation of the readily adhesive layer at the time of heating. When this value is 0.1 or more, the readily adhesive layer is properly deformed at the time of image transfer and the transfer is achieved well, and therefore, such is preferable.

The rigid pendulum attenuation factor can be measured as follows. That is, a sample having a size of 3 cm×5 cm is heated at a prescribed temperature, a rigid body (diameter: 0.5 cm, length: 2 cm, material quality: brass) is placed on the readily adhesive layer, and pendulums (weight: 15 g) are hung directly below by 9 cm from the both ends of the rigid body. The pendulums at the both ends of the rigid body are simultaneously vibrated, and an attenuation factor of amplitude of the vibration is measured. This attenuation factor of amplitude is the rigid pendulum attenuation factor. Specifically, the attenuation factor of amplitude can be measured by a rigid pendulum viscoelasticity analyzer (manufactured by Oriontec Co., Ltd.).
(e) The surface roughness, the coefficient of static friction, and the rigid pendulum attenuation factor of the readily adhesive layer can be adjusted mainly by selecting raw materials of the readily adhesive layer, for example, a mat particle and a resin to be used in the readily adhesive layer.

As the mat particle to be used in the readily adhesive layer, ones having a mean particle size of from 0.5 to 20 μm are preferable, and ones having a mean particle size of from 2 to 10 μm are more preferable in the invention. Specific examples of the mat particle include polymethyl methacrylate (PMMA), silicone, silica, polypropylene, polystyrene, and ones described in paragraph (0074) of JP-A-2002-337478. Of these, PMMA and silicone are preferable.

Also, the content of the mat particle in the readily adhesive layer is preferably from 0.05 to 10% by weight, and more preferably from 0.1 to 5% by weight based on the whole of the readily adhesive layer.
(f) A Vicat softening point is preferably not higher than 100° C., and more preferably from 30 to 80° C. The Vicat softening point is an index to exhibit easiness of deformation of the readily adhesive layer at the time of heating. When this value not higher than 100° C., the readily adhesive layer is properly deformed at the time of image transfer and the transfer is achieved well, and therefore, such is preferable.

The rigid pendulum attenuation factor and the Vicat softening point can be adjusted mainly by selecting raw materials of the readily adhesive layer.

Examples of the raw materials which can be used for the readily adhesive layer include synthetic resins such as cellulose derivatives (for example, nitrocellulose, ethyl cellulose, and cellulose acetate propionate), styrene based resins (for example, polystyrene and poly-α-methylstyrene), acrylic resins (for example, polymethyl meth-acrylate and polyethyl acrylate), vinyl based resins (for example, polyvinyl chloride, polyvinyl acetate, vinyl chloride-vinyl acetate copolymers, polyvinyl butyral, and polyvinyl acetal), polyester resins, polyamide resins, epoxy resins, polyurethane resins, petroleum resins, ionomers, ethylene-acrylic copolymers, and ethylene-acrylic ester copolymers; natural resins and synthetic rubber derivatives such as rosin, rosin-modified maleic acid resins, ester gums, polyisobutylene rubbers, butyl rubbers, styrene-butadiene rubbers, butadiene-acrylonitrile rubbers, polyamide resins, and poly-(chlorinated olefin)s. These may be used in admixture of two or more kinds thereof. Of the foregoing resins, polyvinyl butyral resins, polyurethane resins, and acrylic resins are preferable.

A thickness of the readily adhesive layer on the final medium to be transferred is preferably from 0.5 to 50 μm, and more preferably from 3 to 40 μm.

As the release paper of the readily adhesive layer-provided release paper, various release papers can be used. Examples thereof include papers such as condenser paper, polyester films, polystyrene films, polypropylene films, and cellophane. Of these, polyester films (specific examples thereof include PET (polyethylene terephthalate) and PEN (polyethylene naphthalate)) are especially preferable because they have high heat resistance.

A thickness of the release paper is suitably from 2 to 50 μm in view of mechanical strength, easiness of handling, or easiness of availability. However, taking into consideration thermal characteristics such as heat conductivity, heat transfer coefficient, and heat accumulation performance, the thickness of the release paper is more suitably from 2 to 16 μm. Also, a surface roughness of the release paper is preferably from 1 to 10 μm, and more preferably from 3 to 7 μm in terms of Rz.

If desired, in the readily adhesive layer-provided release paper, a backcoat layer may be provided on the surface opposite to the surface on which the readily adhesive layer of the release paper is provided, whereby the heat resistance and slipperiness can be enhanced. Especially, in the case where the thermal transfer condition is severe as in the case of high-speed thermal transfer, it is preferred to provide a backcoat layer.

In the readily adhesive layer-provided release paper, the readily adhesive layer can be formed by coating an adhesive layer forming composition on one surface of the release paper by a coating method such as gravure coating, wire bar coating, and roll coater coating and then drying it. Also, in the case where the backcoat layer is provided, it may be provided by coating a backcoat forming composition on the other surface of the release paper and then drying it.

As the transparent support of the final medium to be transferred, various plastic films can be used. Examples thereof include various plastic films or sheets made of a single layer or a laminate of two or more layers, such as vinyl chloride based resin sheets, ABS resin sheets, polyethylene terephthalate films, polybutylene terephthalate films, polyethylene naphthalate films, polyacrylate films, polycarbonate films, polyether-ketone films, polysulfone films, polyethersulfone films, polyether-imide films, polyimide films, polyethylene films, polypropylene films, polystyrene films, syndiotactic polystyrene films, stretched nylon films, polyacetate films, and polymethyl methacrylate films.

A thickness of such a transparent support is preferably from 25 to 150 μm, and more preferably from 40 to 100 μm.

For the purpose of preventing defects of the readily adhesive layer or the like caused due to the attachment of a foreign matter, it is preferable that the transparent support of the final medium to be transferred is subjected to an antistatic treatment. Examples of the method of the antistatic treatment include a method in which a film containing a conductive fine particle such as metal oxides is molded and provided with an antistatic layer. As the antistatic agent, known antistatic agents can be used.

In the invention, it is preferable that in the readily adhesive layer of the final medium to be transferred, its surface is covered by a release sheet, and the release sheet is peeled apart immediately before transferring the image. When the surface of the readily adhesive layer is covered by the release sheet, in storing or shipping the final medium to be transferred in the piled state, it is possible to prevent blocking caused by the readily adhesive layers between the final media to be transferred. Therefore, such is preferable.

Examples of the release sheet to be used herein include the foregoing release paper to be used for the readily adhesive layer-provided release paper.

In the invention, the foregoing final medium to be transferred having the readily adhesive layer on the transparent support is used for the image formation.

It is preferable that the image transfer onto the readily adhesive layer of the final medium to be transferred is carried out by superimposing the final medium to be transferred and the intermediate transfer medium and heating them under pressure. For heating under pressure, a usual thermal transfer device can be used. For example, a laminate resulting from superimposing the final medium to be transferred and the intermediate transfer medium is passed between a pair of heat rollers and heated under pressure, thereby making the image receiving layer of the intermediate transfer medium and the image adhere to the readily adhesive layer of the final medium to be transferred; and thereafter, the intermediate transfer medium is peeled apart, whereby the image can be transferred together with the image receiving layer onto the fine medium to be transferred. During this, it is preferred to cover the upper and lower sides of the laminate by a cover sheet, place the laminate on a guide plate such as an aluminum plate and pass it between the heat rollers. By using the guide plate and the cover sheet, the generation of a wrinkle and the like and dimensional change are suppressed, whereby the transfer can be achieved well.

The heating temperature is preferably from 90 to 160° C., and more preferably from 110 to 140° C. The pressurizing pressure is preferably from 1 to 100 N/cm, and more preferably from 2 to 10 N/cm.

In the image forming method of the invention, after transferring the image onto the final medium to be transferred, the surface of the readily adhesive layer having the transferred image is subjected to a smoothening treatment.

By performing this smoothening treatment, a surface irregularity (mainly derived from the release paper) which the readily adhesive layer on the final medium to be transferred has can be smoothened. In this way, it is possible to enhance the transparency of an exposed portion where the image of the readily adhesive layer is not transferred and which becomes a non-image area. Also, since an image area is smoothened, too, a glossy image having high image quality can be obtained.

By performing this smoothening treatment, a glossiness after treating the surface of the readily adhesive layer having the transferred image is increased preferably by from 5 to 100%, and more preferably from 20 to 80% in both the image area and the non-image area as compared with that before the treatment.

It is preferable that the smoothening treatment is carried out by superimposing a cover sheet on the surface of the readily adhesive layer having the transferred image and heating them under pressure. The heating under pressure can be carried out by utilizing a usual thermal transfer device. Specifically, the final medium to be transferred resulting from superimposing a cover sheet on the surface of the readily adhesive layer is passed between a pair of heat rollers and heated under pressure. During this, it is preferred to place the laminate on a guide plate such as an aluminum plate and pass it between the heat rollers. By using the guide plate and the cover sheet, the generation of a wrinkle and the like and dimensional change are suppressed, whereby the transfer can be achieved well.

The heating temperature is preferably from 90 to 160° C., and more preferably from 110 to 140° C. The pressurizing pressure is preferably from 1 to 100 N/cm, and more preferably from 2 to 10 N/cm.

In the cover sheet to be used for the smoothening treatment, a coefficient of static friction of the surface thereof against the surface of an image receiving material is preferably not more than 0.5, and more preferably from 0.1 to 0.3. When the coefficient of static friction falls within the foregoing range, the final medium to be transferred and the cover sheet can be brought into smooth contact with each other; the generation of a wrinkle can be suppressed at the time of smoothening treatment; and an image having high image quality, which is free from uneven gloss and deformation, and good transparency in a non-image area can be obtained. Therefore, such is preferable.

Also, a surface roughness of the cover sheet is preferably from 0.1 to 3.0 μm, and more preferably from 0.3 to 1.0 μm in terms of Rz. Since the surface irregularity of the readily adhesive layer is strongly reflected by an irregularity of the cover sheet, it is preferred to make Rz fall within the foregoing range in view of obtaining an image having high image quality and good transparency in a non-image area.

Examples of the cover sheet include CERAPEEL #100S, manufactured by Toyo Metallizing Co., Ltd., which is a surface release treatment film.

As the cover sheet which is used at the time of transfer of the readily adhesive layer or at the time of image transfer as described above, the same cover sheet to be used at the time of smoothening treatment can be used.

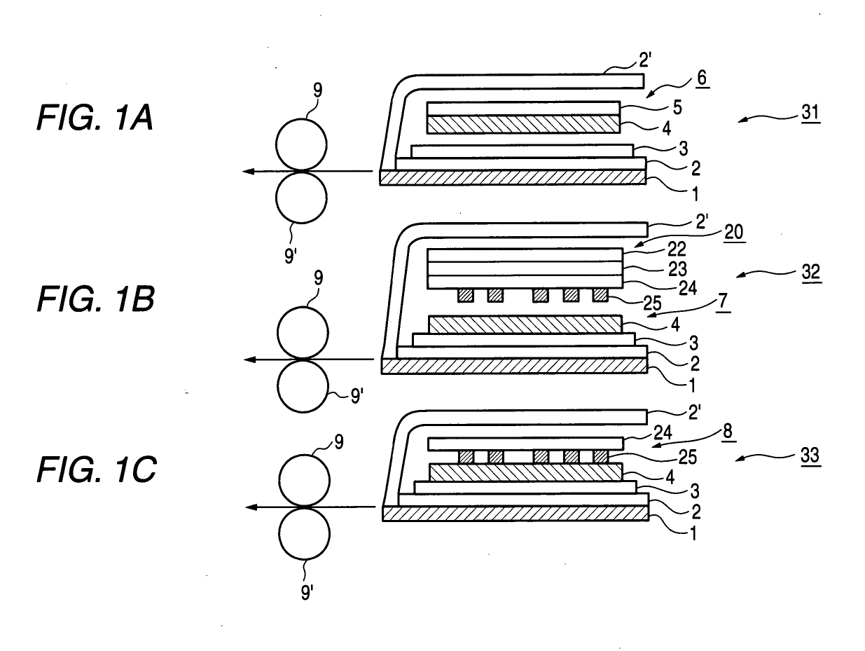

An example of the embodiment of the image forming method of the invention as described above will be hereunder described with reference to FIG. 1. FIG. 1A is an outline view to show a step of transferring a readily adhesive layer onto a transparent support of a final medium to be transferred by using readily adhesive layer-provided release paper; FIG. 1B is an outline view to show a step of transferring an image onto a readily adhesive layer of a final medium to be transferred; and FIG. 1C is an outline view to show a step of subjecting the surface of a readily adhesive layer of a final medium to be transferred having a transferred image to a smoothening treatment.

As shown in FIG. 1A, in a step of transferring a readily adhesive layer onto a transparent support of a final medium to be transferred, first of all, a cover sheet 2 is placed on an aluminum guide plate 1, and a transparent support 3 of a final medium to be transferred is further placed thereon. Then, readily adhesive layer-provided release paper 6 composed of a readily adhesive layer 4 and release paper 5 is laminated thereon and further covered by a cover sheet 2′. A laminate 31 as thus obtained is passed between a pair of heat rollers 9, 9′ and heated under pressure, thereby transferring the readily adhesive layer 4 onto the transparent support 3 of a final medium to be transferred. The release paper 5 is peeled apart, thereby obtaining a final medium 7 to be transferred having a readily adhesive layer on a transparent support.

As shown in FIG. 1B, in a step of transferring an image onto a final medium to be transferred, first of all, a cover sheet 2 is placed on an aluminum guide plate 1, and the above-obtained final medium 7 to be transferred having a readily adhesive layer on a transparent support is further placed thereon. Then, an image receiving material (inter-mediate transfer medium) 20 composed of a support 22, a cushioning layer 23, and an image receiving layer 24 having an image 25 formed thereon is laminated thereon and further covered by a cover sheet 2′. A laminate 32 as thus obtained is passed between a pair of heat rollers 9, 9′ and heated under pressure, thereby transferring the image 25 together with the image receiving layer 24 onto the readily adhesive layer 4. The image receiving material 20 is peeled apart, thereby obtaining a final medium 8 to be transferred having a transferred image.

As shown in FIG. 1C, in a step of achieving a smoothening treatment, first of all, a cover sheet 2 is placed on an aluminum guide plate 1, and the above-obtained final medium 8 to be transferred having a transferred image is placed thereon and covered by a cover sheet 2′. A laminate 33 as thus obtained is passed between a pair of heat rollers 9, 9′ and heated under pressure, thereby subjecting the surface of readily adhesive layer having a transferred image (surface of an image receiving layer 24) to a smoothening treatment.

The intermediate transfer medium which is used in the image forming method of the invention as described above will be hereunder described.

The intermediate transfer medium is an image receiving material capable of re-transferring an image. It is preferable that image recording on this intermediate transfer medium is thermal transfer recording. The image recording is preferably laser thermal transfer recording in view of the matter that an image with high resolution can be formed.

In the laser thermal transfer recording, in general, by using a thermal transfer material provided with a light-to-heat conversion layer and an image forming layer and the like and an intermediate transfer medium provided with an image receiving layer and the like, an image is recorded on the image receiving layer of the intermediate transfer medium.

In order to form a multicolor image by laser thermal transfer recording, at least two kinds of thermal transfer materials having an image forming layer of a different color from each other and an image receiving material are used as a multicolor image forming material. The thermal transfer materials having an image forming layer having a different color from each other are preferably four or more kinds, and more preferably five or more kinds. In the case of four or five or more kinds, colors of the image forming layers are preferably yellow (Y), magenta (M), cyan (C) and white (W) and/or metallic gloss. Further, ones resulting from adding black (K) to the foregoing colors are preferable. The thermal transfer materials may contain other colors which cannot be expressed by a combination of process colors, such as green (G), orange (O), red (R), blue (B), gold (Go), and pink (P).

In the invention wherein the final medium to be transferred is transparent, it is preferable that the thermal transfer material of at least one color is a white thermal transfer material or a metallically glossy thermal transfer material. Since such a white or metallically glossy color can be used as a base color of the image having a hiding power, it is preferred to contain a white or metallically glossy color in the mage by using these thermal transfer materials in forming a clear image having high image quality on the transparent final medium to be transferred. Alternatively, it is also possible to contain both white and metallically glossy colors.

In a laser thermal transfer type multicolor image forming material, it is desired to control a light-to-heat conversion layer of the thermal transfer material of at least one color such that a ratio A/X wherein A represents an absorbance of the light-to-heat conversion layer at 808 nm, and X represents a thickness (μm) of the light-to-heat conversion layer is preferably 2.5 to 3.2, and more preferably from 2.7 to 3.0 and that the absorbance A is preferably from 1.0 to 2.0, and more preferably 1.3 to 1.7.

By making the ratio (A/Y) of the absorbance A of the light-to-heat conversion layer to the thickness X (μm) of the light-to-heat conversion layer fall within the foregoing specific range, it is possible to suppress the coloration of the image forming layer caused due to a decomposition product of a light-to-heat conversion dye at a minimum level, to increase the sensitivity at the time of recording and to make the image quality in a good state.

Also, by making the A/X ratio fall within the foregoing range, it is possible to record an image of a large size of (515 mm or more)×(728 mm or more) with a resolution of the transferred image of preferably 2,400 dpi or more, and more preferably 2,600 dpi.

The absorbance A as referred to herein means an absorbance of the light-to-heat conversion layer at a peak wavelength of laser beams to be used of 808 nm and can be measured by using a known spectrophotometer. In the invention, a UV spectrophotometer UV-240, manufactured by Shimadzu Corporation was used. Also, the foregoing absorbance is a value obtained by subtracting a value of the support alone from a value including that of support.

In the thermal transfer image by a laser thermal transfer type multicolor image forming material to be used in the invention, since the dot shape is sharp, thin lines of very fine characters can be reproduced with good sharpness. In the thermal transfer material, heat generated by the laser beams is transferred to the transfer interface without being diffused in the plane direction of the light-to-heat conversion layer, and the image forming layer is sharply broken at the interface between a heated area and non-heated area. Accordingly, it is desired to make the light-to-heat conversion layer in the thermal transfer material thin and to control the dynamic characteristics of the image forming layer.

According to the simulation, it is estimated that the light-to-heat conversion layer instantaneously reaches about 700° C., and if the film is thin, deformation and breakage are liable to occur. When deformation and breakage occur, there are generated such actual damages that the light-to-heat conversion layer is transferred together with the transfer layer into the image receiving layer and that the transferred image becomes non-uniform. On the other hand, in order to obtain the prescribed temperature, the light-to-heat conversion substance must be contained in a high concentration in the film, and there are generated problems such as deposition of the dye and migration of the dye into adjacent layers.

For that reason, it is preferable that the light-to-heat conversion layer is made thin so as to have a thickness of not more than about 0.5 μm by selecting an infrared light absorbing dye having excellent light-to-heat conversion characteristics and a heat resistant binder such as polyamide-imide based compounds and polyimide based compounds.

Also, in general, if deformation of the light-to-heat conversion layer occurs, or the image forming layer itself is deformed by high temperatures, the image forming layer which has been transferred onto the image receiving layer causes uneven thickness corresponding to a sub-scanning pattern, whereby the image becomes non-uniform and the transfer density is lowered. This tendency becomes remarkable when the thickness of the image forming layer is thin. On the other hand, when the thickness of the image forming layer is thick, the sharpness of the dot is deteriorated, and the sensitivity is lowered.

For the sake of cope with both of these reciprocal performances, it is preferred to improve uneven transfer by adding a low melting substance such as waxes to the image forming layer. Also, by adding an inorganic fine particle in place of the binder to properly increase the layer thickness, the image forming layer is sharply broken at the interface between a heated area and a non-heated area, whereby the uneven transfer can be improved while keeping the sharpness of dot and sensitivity.

Also, in general, when the coating layer of the thermal transfer material absorbs moisture, the dynamic properties and thermal properties of the layer change, and temperature and relative humidity dependence of the recording environment is generated.

In order to render this temperature and relative humidity dependence low, it is preferred to use an organic solvent system for the dye/binder system of the light-to-heat conversion layer and the binder system of the image forming layer.

Further, if the infrared light absorbing dye is migrated into the image forming layer from the light-to-heat conversion layer due to high temperatures at the time of printing, hue is changed. Accordingly, in order to prevent this matter, it is preferred to design the light-to-heat conversion layer by a combination of an infrared light absorbing dye and a binder having a strong retention force as described above.

In the image formation, it is preferable that the image receiving material and the thermal transfer material are retained on a drum due to vacuum adhesion. According to this vacuum adhesion, the image is formed by controlling the adhesive force between the both materials. Thus, the image transfer behavior is very sensitive to a clearance between the surface of the image receiving layer of the image receiving material and the surface of the image forming layer of the transfer material and therefore, is important. When the clearance between the both materials is widened due to a foreign matter such as dusts, image defects or uneven image transfer is generated.

In order to prevent such image defects or uneven image transfer from occurring, it is preferable that by imparting a uniform irregularity to the thermal transfer material or image receiving material, scouring of air is improved, thereby obtaining a uniform clearance. As a method for imparting an irregularity, in general, there are enumerated a post treatment such as embossing and the addition of a matting agent to the coating layer. For the purposes of simplifying the manufacturing step and stabilizing the material with time, the addition of a matting agent is preferable.

For the sake of surely reproducing sharp dots, the side of the recording device is also required to be designed with high precision. Concretely, ones described in paragraph (0027) of JP-A-2002-337468 are employed, but it should not be construed that the invention is limited thereto.

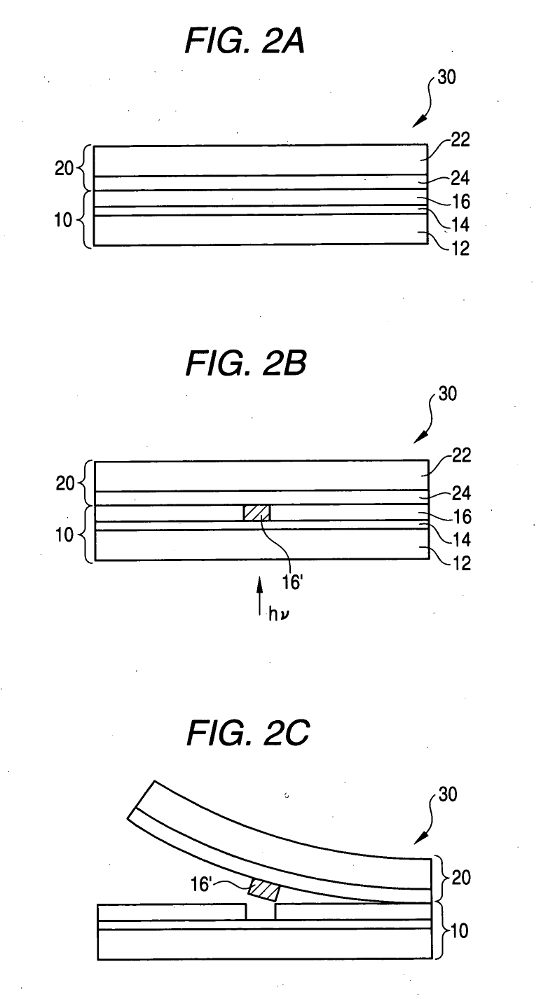

Next, an outline view of the mechanism of multicolor image formation by thin film thermal transfer using laser will be described with reference to FIG. 2.

An image forming laminate 30 having an image receiving material 20 laminated thereon is prepared on the surface of an image forming layer 16 of a thermal transfer material 10. The thermal transfer material 10 has a light-to-heat conversion layer 14 on a support 12 and further an image forming layer 16 on the light-to-heat conversion layer 14; the image receiving material 20 has an image receiving layer 24 on a support 22; and the image receiving layer 24 is laminated on the surface of the image forming layer 16 of the thermal transfer material 10 such that it comes into contact therewith (FIG. 2A). When laser beams are imagewise irradiated in time sequence from the side of the support 12 of the thermal transfer material 10 of the laminate 30, a region 16′ to be irradiated with laser beams of the light-to-heat conversion layer 14 of the thermal transfer material 10 causes the generation of heat, whereby an adhesion strength to the image forming layer 16 is lowered (FIG. 2B). Thereafter, when the image receiving material 20 is peeled apart from the thermal transfer material 10, the region 16′ to be irradiated with laser beams of the image forming layer 16 is transferred onto the image receiving layer 24 of the image receiving material 20 (FIG. 2C).

With respect to the kind, intensity, beam diameter, power, scanning speed, etc of laser beams to be used for the light irradiation, concretely, ones described in paragraph (0041) of JP-A-2002-337468 are employed, but it should not be construed that the invention is limited thereto.

With respect to a method for forming a multicolor image, the multicolor image may be formed by using the plural number of the foregoing thermal transfer materials and repeatedly superimposing many image layers (image forming layers having an image formed therein) on the same image receiving material; or multicolor images may be formed on paper for regular printing by once forming images on image layers of plural image materials and re-transferring them onto paper for regular printing (final medium to be transferred).

With respect to the thermal transfer recording using laser beam irradiation, so far as laser beams are converted into heat and a pigment-containing image forming layer is transferred into an image receiving material by utilizing that heat energy, whereby an image can be formed on the image receiving material, all of the solid state, the softened state, the liquid state, and the gaseous state are included irrespective of the state change of the pigment, dye and image forming layer at the time of transfer. Of these, the solid state and the softened state are preferable. For example, conventionally known hot-melt type transfer, transfer by abrasion, sublimation type transfer, and so on are included.

Above all, the foregoing thin film transfer type and hot-melt or abrasion type is preferable in view of forming an image of hue similar to printing.

The image prepared on the image receiving material (intermediate transfer medium) or paper for regular printing (final medium to be transferred) can be subjected to a post exposure treatment by light having intensity in an ultraviolet light region, too. It is possible to discolor the coloration by an infrared light absorbing dye or a decomposition product thereof in the image forming layer by using a photo-radical generator. By the post exposure treatment, it is possible to prevent the change of hue due to the exposure with light in the room.

As a light source of the post exposure treatment, ones having a wavelength which the photo-radical generator absorbs are preferable, and examples thereof include fluorescent lamps, black lights, and metal halide lamps.

When the device for performing laser thermal transfer or the thermal transfer device for performing the image forming method of the invention is connected to a plate-making system, a system capable of exhibiting a function as a color proof will be constructed. With respect to the system, it is necessary that a printed matter having image quality limitlessly closed to a printed matter outputted from a certain plate-making data be outputted from the foregoing recording device. Thus, software for making the color and halftone dots closed to those of a printed matter is necessary. With respect to specific system connection, for example, concretely, ones described in paragraph (0040) of JP-A-2002-337468 are employed, but it should not be construed that the invention is limited thereto.

The thermal transfer material and the image receiving material, each of which is suitably used in the invention, will be hereunder described.

Thermal Transfer Material

The thermal transfer material has at least a light-to-heat conversion layer and an image forming layer on a support and further has other layers, if desired.

Support

A material of the support of the thermal transfer material is not particularly limited, and various support materials can be used as the need arises. Specifically, ones described in paragraph (0051) of JP-A-2002-337468 are employed, but it should not be construed that the invention is limited thereto.

In the support of the thermal transfer material, for the purpose of enhancing its adhesion to the light-to-heat conversion layer to be provided thereon, the support may be subjected to a surface activation treatment and/or provided with one or two or more undercoat layers. Examples of the surface activation treatment include a glow discharge treatment and a corona discharge treatment. As materials of the undercoat layer, ones having high adhesion to both the surface of the support and the surface of the light-to-heat conversion layer, having low heat conductivity and having excellent heat resistance are preferable. Examples of the material of the undercoat layer include polystyrene, styrene-butadiene copolymers, and gelatin. A thickness of the whole of the undercoat layers is usually from 0.01 to 2 μm. Also, the surface of the thermal transfer material opposite to the side at which the light-to-heat conversion layer is provided may be provided with various functional layers such as an antireflection layer and an antistatic layer or may be subjected to a surface treatment, if desired. Specifically, a back layer described in paragraph (0053) of JP-A-2002-337468 can be used, but it should not be construed that the invention is limited thereto.

Light-to-Heat Conversion Layer

The light-to-heat conversion layer contains a light-to-heat conversion substance, a binder, and a matting agent and further contains other components, if desired.

The light-to-heat conversion substance is a substance having a function to convert light energy to be irradiated into heat energy. In general, the light-to-heat conversion substance is a dye capable of absorbing laser beams (inclusive of a pigment, hereinafter the same). In the case where the image recording is performed by infrared light laser, it is preferred to use an infrared light absorbing dye as the light-to-heat conversion substance. Examples of such a dye include black pigments such as carbon black; pigments of a large cyclic compound having absorption in the visible to near infrared light regions, such as phthalocyanine and naphthalocyanine; organic dyes to be used as a laser absorbing material of high-density laser recording such as optical disks (for example, cyanine dyes such as indolenine dyes, anthraquinone based dyes, azulene based dyes, and phthalocyanine dyes), organometallic compound dyes such as dithiol-nickel complexes. Of these, cyanine based dyes are preferable for the following reasons. That is, since the cyanine based dyes exhibit a high absorptivity coefficient against light in the infrared light region, when used as the light-to-heat conversion substance, the light-to-heat conversion layer can be made thin. As a result, it is possible to more enhance the recording density of the thermal transfer material.

For the light-to-heat conversion substance, except for dyes, inorganic materials such as particulate metal materials such as a blackened silver etc. can be used.

In the invention, as the light-to-heat conversion substance, a compound represented by the following general formula (1) is extremely preferably used because it has excellent heat resistance, and a coating liquid thereof is not decomposed with time, and the absorbance is not lowered.

General Formula (1)

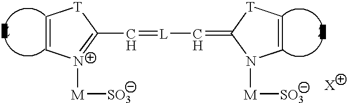

In the general formula (1), Z represents an atomic group for forming a benzene ring, a naphthalene ring, or a heteroaromatic ring. T represents —O—, —S—, —Se—, —N(R¹)—, —C(R²)(R³)—, or —C(R⁴)═C(R⁵)—. R¹, R², and R³ each independently represents an alkyl group, an alkenyl group, or an aryl group; and R⁴ and R⁵ each independently represents a hydrogen atom, a halogen atom, an alkyl group, an aryl group, an alkoxy group, an aryloxy group, a carboxyl group, an acyl group, an acylamino group, a carbamoyl group, a sulfamoyl group, or a sulfonamide group. L represents a trivalent connecting group resulting from connection of five or seven methylene groups by a conjugated double bond. M represents a divalent connecting group. X⁺ represents a cation.

In the general formula (1), examples of the ring completed by Z include a benzene ring, a naphthalene ring, a pyridine ring, a quinoline ring, a pyrazine ring, and a quinoxaline ring. Also, other substituent R⁶ may further be bonded on Z. Examples of the substituent R⁶ include various substituents such as an alkyl group, an aryl group, a heterocyclic residue, a halogen atom, an alkoxy group, an aryloxy group, an alkylthio group, an arylthio group, an alkylcarbonyl group, an arylcarbonyl group, an alkyl-oxycarbonyl group, an aryloxycarbonyl group, an alkylcarbonyloxy group, an arylcarbonyloxy group, an alkylamide group, an arylamide group, an alkylcarbamoyl group, an arylcarbamoyl group, an alkylamino group, an arylamino group, a carboxyl group, an alkylsulfonyl group, an arylsulfonyl group, an alkylsulfonamide group, an arylsulfonamide group, an alkylsulfamoyl group, an arylsulfamoyl group, a cyano group, and a nitro group. The number (p) of the substituents to be bonded on Z is usually 0 or from approximately 1 to 4. Incidentally, when p is 2 or more, plural R⁶s may be the same or different.

Of the substituents represented by R⁶, a halogen atom (for example, F and Cl), a cyano group, a substituted or unsubstituted alkoxy group having from 1 to 20 carbon atoms (for example, a methoxy group, an ethoxy group, a dodecyloxy group, and a methoxyethoxy group), a substituted or unsubstituted phenoxy group having from 6 to 20 carbon atoms (for example, a phenoxy group, a 3,5-dichlorophenoxy group, and a 2,4-di-t-pentylphenoxy group), a substituted or unsubstituted alkyl group having from 1 to 20 carbon atoms (for example, a methyl group, an ethyl group, an isobutyl group, a t-pentyl group, an octadecyl group, and a cyclohexyl group), and a substituted or unsubstituted phenyl group having from 6 to 20 carbon atoms (for example, a phenyl group, a 4-methylphenyl group, a 4-trifluoromethylphenyl group, and a 3,5-dichlorophenyl group).

In the foregoing general formula (1), T represents —O—, —S—, —Se—, —N(R¹)—, —C(R²)(R³)—, or —C(R⁴)═C(R⁵)—. In this case, as the group represented by R¹, R², R³, R⁴, and R⁵, substituted or unsubstituted alkyl group, aryl group and alkenyl group are preferable; and an alkyl group is especially preferable. The number of carbon atoms of the group represented by R¹ to R⁵ is preferably from 1 to 30, and especially preferably from 1 to 20.

Also, in the case where the group represented by R¹ to R⁵ further has a substituent, preferred examples of the substituent include a sulfonic group, an alkylcarbonyloxy group, an alkylamide group, an alkylsulfonamide group, an alkoxycarbonyl group, an alkylamino group, an alkylcarbamoyl group, an alkylsulfamoyl group, an alkoxy group, an aryloxy group, an alkylthio group, an arylthio group, an alkyl group, an aryl group, a carboxyl group, a halogen atom, and a cyano group.

Of these substituents, a halogen atom (for example, F and Cl), a cyano group, a substituted or unsubstituted alkoxy group having from 1 to 20 carbon atoms (for example, a methoxy group, an ethoxy group, a dodecyloxy group, and a methoxyethoxy group), a substituted or unsubstituted phenoxy group having from 6 to 20 carbon atoms (for example, a phenoxy group, a 3,5-dichlorophenoxy group, and a 2,4-di-t-pentylphenoxy group), a substituted or unsubstituted alkyl group having from 1 to 20 carbon atoms (for example, a methyl group, an ethyl group, an isobutyl group, a t-pentyl group, an octadecyl group, and a cyclohexyl group), and a substituted or unsubstituted phenyl group having from 6 to 20 carbon atoms (for example, a phenyl group, a 4-methylphenyl group, a 4-methylphenyl group, a 4-trifluoromethylphenyl group, and a 3,5-dichlorophenyl group) are especially preferable. R¹ to R⁵ are most preferably an unsubstituted alkyl group having from 1 to 8 carbon atoms; and T is especially preferably —C(CH₃)₂—.

In the general formula (1), L represents a trivalent connecting group resulting from connection of five or seven methylene groups by a conjugated double bond, which may be substituted. That is, L represents a pentamethylene group or a heptamethylene group wherein the methylene groups are connected to each other via a conjugated double bond, and specifically, groups represented by the following (L-1) to (L-6) are preferable.

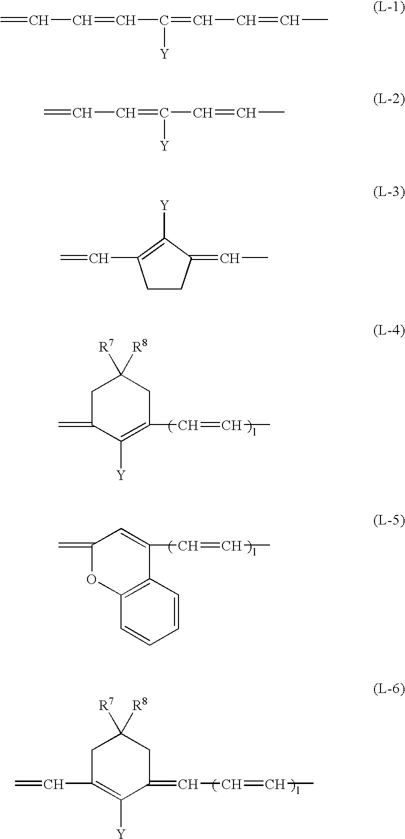

Of the foregoing specific examples, connecting groups of forming tricarbocyanine as enumerated by (L-2), (L-3), (L-4), (L-5) and (L-6) are especially preferable. In the foregoing formulae (L-1) to (L-6), Y represents a hydrogen atom or a monovalent group. Preferred examples of the monovalent group represented by Y include a lower alkyl group (for example, a methyl group), a lower alkoxy group (for example, a methoxy group), a substituted amino group (for example, a dimethylamino group, a diphenylamino group, a methylphenylamino group, a morpholino group, an imidazolidine group, and an ethoxycarbonylpiperazine group), an alkylcarbonyloxy group (for example, an acetoxy group), an alkylthio group (for example, a methylthio group), a cyano group, a nitro group, and a halogen atom (for example, Br, Cl, and F).

Of the groups represented by Y, a hydrogen atom is especially preferable. R⁷ and R⁸ are each especially preferably a hydrogen atom or a lower alkyl group (for example, a methyl group). Also, in the formulae (L-4) to (L-6), i is 1 or 2, and j is 0 or 1. M represents a divalent connecting group, and preferably a substituted or unsubstituted alkylene group having from 1 to 20 carbon atoms (for example, an ethylene group, a propylene group, and a butylene group).

In the general formula (I), examples of the cation represented by X⁺ include a metal ion (for example, Na+ and K⁺), an ammonium ion (for example, an ion represented by HN⁺(C₂H₅)₃), and a pyridinium ion.

Specific examples of the compound represented by the general formula (1) will be given below, but it should not be construed that the invention is limited thereto.

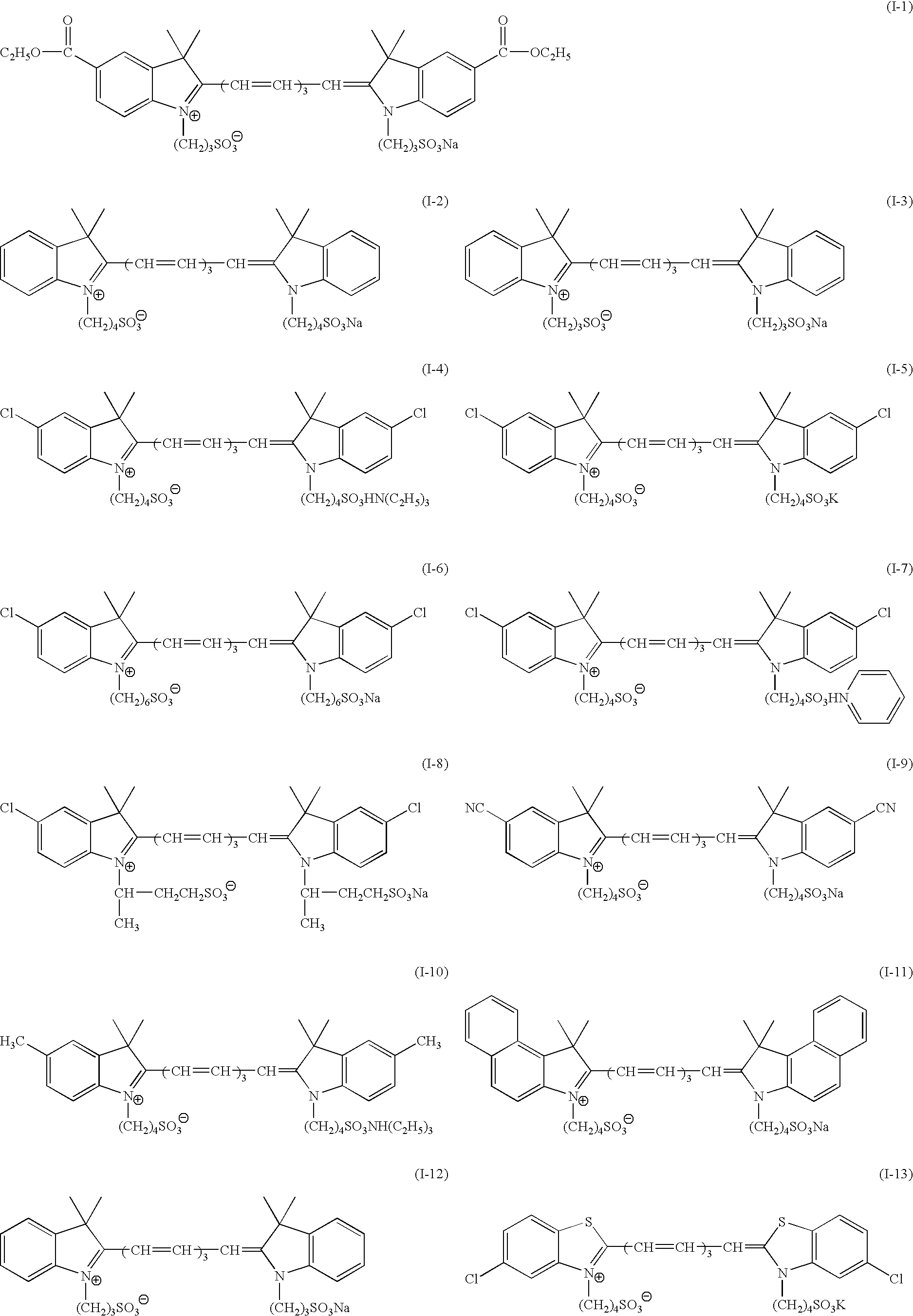

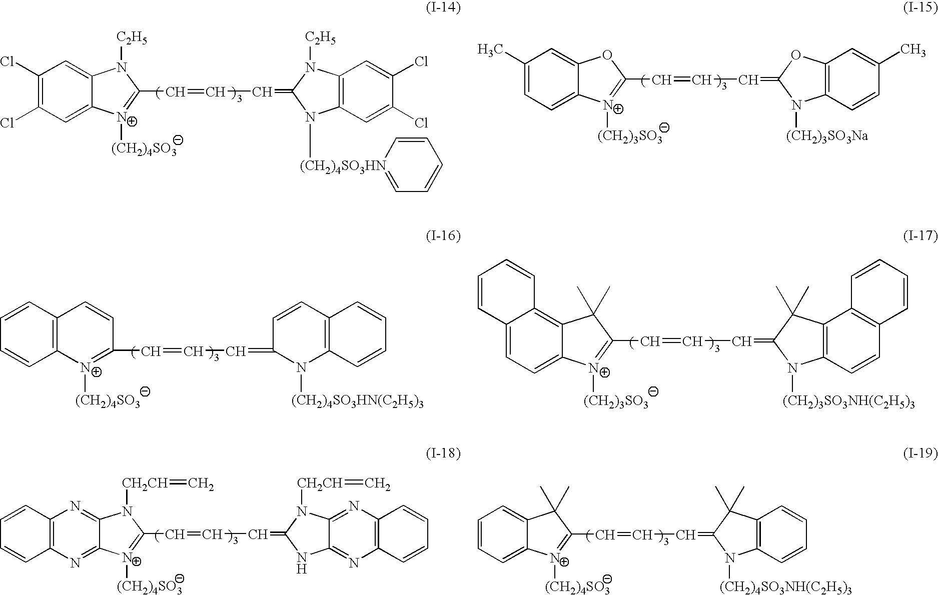

The compound represented by the foregoing general formula (I) can be in general easily synthesized in the same manner as in the case of synthesizing a carbocyanine dye. That is, the compound represented by the general formula (I) can be easily synthesized by reacting a heterocyclic enamine with an acetal (for example, CH₃O—CH═CH—CH═CH—CH(OCH₃)₂) or a compound represented by PhN-CH—(CH—CH)—NHPh. Here, Ph represents a phenyl group. Also, with respect to the synthesis method of such compounds, specifically, the description of JP-A-5-116450 and the like can be made hereof by reference.

If the light-to-heat conversion substance has a high decomposition temperature so that it is hardly decomposed, it is possible to prevent failures of fogging due to coloration of a decomposition product thereof from occurring. From this viewpoint, the decomposition temperature of the light-to-heat conversion substance is preferably 200° C. or higher, and more preferably 250° C. or higher. When the decomposition temperature is lower than 200° C., coloration of a decomposition product formed by decomposition of the light-to-heat conversion causes fogging, thereby lowering the image quality.

As a binder to be contained in the light-to-heat conversion layer, polyimide resins and polyamide-imide resins are preferable.

The polyamide-imide resin is not particularly limited so far as it is soluble in a solvent and functions as a binder. However, a resin having at least a strength such that it can form a layer on the support and having high heat conductivity is preferable.

Also, the polyamide-imide as the binder is preferably a polyamide-imide having a heat decomposition temperature (a temperature at which the weight is decreased by 5% in an air stream at a temperature-rise rate of 10° C./min by the TGA method (thermogravimetric analysis method) of 400° C. or higher, and more preferably one having a heat decomposition temperature of 500° C. or higher. Also, the polyamide-imide preferably has a glass transition temperature of from 200 to 400° C. and more preferably has a glass transition temperature of from 250 to 350° C. When the glass transition temperature is lower than 200° C., there is some possibility that fogging is generated in an image to be formed, and when it is higher than 400° C., there is some possibility that the solubility of the resin is lowered, thereby lowering the production efficiency.

It is preferable that the heat resistance of the binder of the light-to-heat conversion layer (for example, the heat deformation temperature and the heat decomposition temperature) is high as compared with that of materials to be used in other layers to be provided on the light-to-heat conversion layer.

The polyamide-imide to be preferably used is a polyamide-imide represented by the following general formula (2).

General Formula (2)

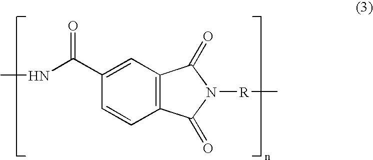

In the foregoing general formula (2), R represents a divalent connecting group. Preferred specific examples of the divalent connecting group will be given below.

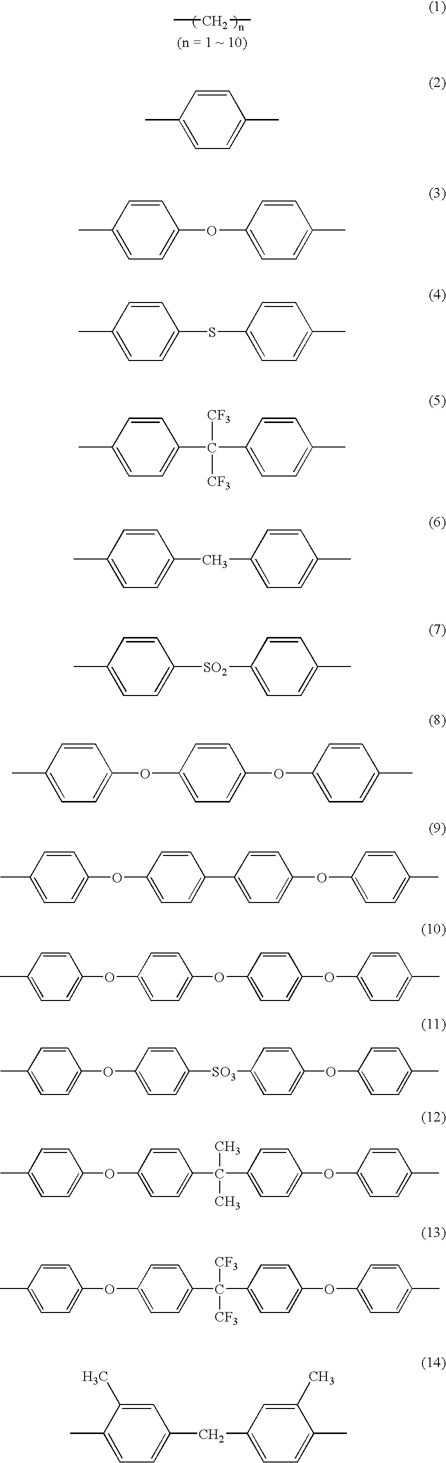

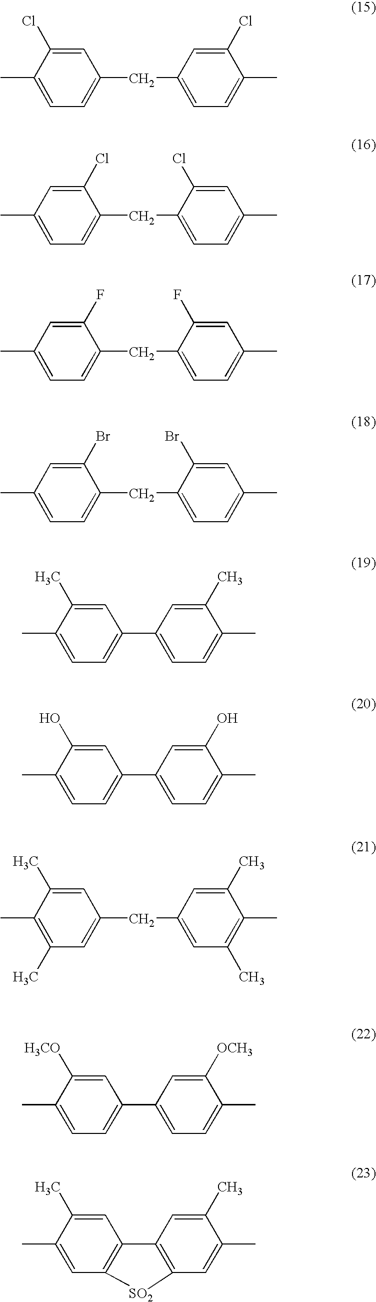

Of these, the connecting groups (6), (7), (11) and (14) are preferable.

Also, these connecting groups may be used singly or in combinations.

A number average molecular weight of the polyamide-imide represented by the general formula (2) is preferably from 3,000 to 50,000, and more preferably from 10,000, to 25,000 in terms of a value as reduced into polystyrene when measured by the gel permeation chromatography.

As the binder of the light-to-heat conversion layer, the polyamide-imide resin may be used in combination with other resin. As the resin with which the polyamide-imide resin is used in combination, for example, ones described in paragraph (0062) of JP-A-2002-337468 are useful, and polyimide resins are preferable. A rate of combination is preferably from 5 to 50%, and more preferably from 10 to 30% in terms of a weight ratio.

As the mat particle to be contained in the light-to-heat conversion layer, for example, ones described in paragraph (0074) of JP-A-2002-337468 are preferable, and silica and silicone resin particles are especially preferable.

Since the silicon resin particle is smaller in specific gravity than the silica particle, it has high liquid stability and therefore, is more preferable. However, as compared with the silica particle, the silicone resin particle has a broad particle size distribution so that giant particles resulting from agglomeration of the plural number of matting agent particles are likely contained. When such an agglomerate is present, image recording does not occur in this portion, and there is some possibility that failures of deletion are generated. For that reason, it is preferred to use a matting agent from which an agglomerate has been removed by a classification treatment. As a method of classification treatment of the matting agent, various methods are properly employable so far as the particles can be classified. Examples of such a method include classification by a sieve, a method by a dry air flow classifier, and a method by a wet air flow classifier. Of these, a method by a dry air flow classifier is preferably employed for the following reasons. That is, it does not require a countermeasure for waste water and is simple as compared with a method by a wet air flow classifier; and it is high in precision and efficiency as compared with a method by a sieve.

As a result, a matting agent composed of particles having a mean particle size of from 0.5 to 5 μm and a content of particles or agglomerates having a length in the long axis direction of 15 μm or more of not more than 100 ppm is preferable. A matting agent composed of particles having a mean particle size in the range of from 1.1 to 3 μm and a content of particles or agglomerates having a length in the long axis direction of 15 μm or more of not more than 20 ppm is more preferable. The mean particle size can be determined by, for example, photographing particles by a scanning electron microscope. An addition amount of the matting agent is preferably from 0.1 to 100 mg/m².

By adding a vinylpyrrolidone copolymer in the light-to-heat conversion layer, it is possible to increase the sensitivity of the thermal transfer material or to enhance the edge sharpness of a printed image.

A copolymerizable component of the vinylpyrrolidone copolymer having such a function is not particularly limited so far as it is incompatible with the polyimide resin or polyamide resin. However, vinyl acetate, styrene, olefins, acrylic acid, and methacrylic acid are especially preferable. One or more kinds of such components can be a copolymerizable component of the vinylpyrrolidone copolymer. In the vinylpyrrolidone copolymer, a molar ratio of vinylpyrrolidone to the copolymerizable component is preferably (50 or more and less than 100)/(more than 0 and 50 or less), and more preferably (60 to 90)/(10 to 40).

A weight average molecular weight of the vinylpyrrolidone polymer or vinylpyrrolidone copolymer is preferably from 2,000 to 500,000, and more preferably from 10,000 to 250,000.

Preferred examples of the vinylpyrrolidone copolymer include vinylpyrrolidone/vinyl acetate copolymers, vinylpyrrolidone/styrene copolymers, vinylpyrrolidone/11-butene copolymers, and vinylpyrrolidone/acrylic acid copolymers.

In the invention, though the vinylpyrrolidone polymer and/or vinylpyrrolidone copolymer is contained in the light-to-heat conversion layer, an embodiment for containing the polymer and/or copolymer is not particularly limited but is arbitrary. In the light-to-heat conversion layer, a blending ratio of the major binder and the vinylpyrrolidone polymer and/or vinylpyrrolidone copolymer is preferably from 0.1 to 30% by weight, and more preferably from 1 to 10% by weight based on the major binder.

In the light-to-heat conversion layer, a surfactant, a thickener, an antistatic agent, and the like may be further added as the need arises.

The light-to-heat conversion layer can be provided by dissolving a light-to-heat conversion substance and a binder; adding a matting agent and other components thereto as the need arises, thereby preparing a coating liquid; and coating the coating liquid on a support and then drying it.

A thickness of the light-to-heat conversion layer is preferably from 0.03 to 1.0 μm, and more preferably from 0.2 to 0.7 μm. Also, the light-to-heat conversion layer preferably has an optical density of from 1.0 to 2.0 against light having a wavelength of 808 nm because the transfer sensitivity of the image forming layer is enhanced. The light-to-heat conversion layer more preferably has an optical density of from 1.3 to 1.8 against light having the foregoing wavelength.

A ratio of the absorbance to the layer thickness (μm) is preferably from 2.0 to 3.5, and more preferably from 2.7 to 3.1. When this ratio is lower than 2.0, the transfer speed becomes low, whereas when it is higher than 3.5, yellow coloration of the transferred image becomes large.

Image Forming Layer

The image forming layer contains at least a pigment which is transferred onto the image receiving material to form an image. Further, the image forming layer contains a binder for forming the layer and a photo-radical generator and other components, if desired.

As the pigment, there are useful not only pigments of process colors such as yellow (Y), magenta (M), cyan (C), and black (K) but also pigments of various colors such as white (W), green (G), orange (O), red (R), blue (B), gold (Go), pink (P), and other metallically glossy color.

The white pigment for a white thermal transfer material will be hereunder described in detail. This white pigment preferably has a particle size of from 0.2 to 0.4 μm.

Usually, for the purposes of enhancing the dispersibility and enhancing the weather resistance, a titanium oxide fine particle is subjected to a surface treatment. In particular, with respect to the weather resistance, since the titanium oxide has photocatalytic properties, it absorbs ultraviolet light to corrode the coating layer. Accordingly, the surface treatment is achieved for the purpose of enclosing the surface of titanium oxide to suppress a photocatalytic activity. The type of the surface treatment can be selected from the following kinds and covering amounts depending upon the purpose. Examples of an inorganic treatment include an alumina treatment, a silica/alumina treatment, a titania treatment, and a zirconia treatment. Examples of an organic treatment include a polyhydric alcohol treatment, an amine treatment, a silicone treatment, and a fatty acid treatment. A silica/alumina treatment is preferable in view of obtaining a high hiding power.

As this white pigment, titanium oxide in which the surface of the particle is coated with alumina and silica (hereinafter sometimes referred to as “titanium oxide for the invention”) is preferable.

The particle size of the titanium oxide for the invention is one obtained by measuring the coated particle and is determined by calculating the weight average particle size from the measured data by TEM.

The coating amount of alumina and silica of the titanium oxide is a proportion against the coated titanium oxide. In order to obtain a high hiding rate, though the coating amount is required to be 5% by weight or more, it is preferably from 6 to 9% by weight. The titanium oxide is preferably rutile type titanium oxide having a higher hiding rate.

Also, in the image forming layer of the white thermal transfer material, it is possible to make the image forming layer have a ratio of the transmission density at the time of measurement using a visual filter to the layer thickness (unit: μm) of the image forming layer (transmission density/layer thickness) of preferably 0.05 to more, and more preferably 0.1 or more. The larger the transmission density, the deeper the white color is. That is, the hiding properties that unnecessary colors are hardly seen through an image as formed on a material to be transferred and that only an image by thermal transfer can be clearly seen become high. The transmission density is preferably approximately 0.2 or more.

Accordingly, the thickness of the image forming layer of the white thermal transfer material in the invention is preferably not more than 2.0 μm, and more preferably not more than 1.5 μm. In the invention, since the layer thickness can be made relatively thin, it is possible to secure both the hiding power and the recording sensitivity.

As the white pigment to be contained in the image forming layer of the white thermal transfer material, calcium carbonate, calcium sulfate, or the like may be used together with the titanium oxide for the invention within the range where the effect of the titanium oxide for the invention is kept.

With respect to the binder of the image forming layer, concretely, ones described in paragraph (0085) of JP-A-2002-337468 are employed, but it should not be construed that the invention is limited thereto.

Next, the pigment for metallically glossy thermal transfer material will be hereunder described in detail. Examples of the metallic particle of pigment include aluminum, gold, bronze, copper, zinc, iron, silver, lead, tin, titanium, and chromium. Of these, an aluminum particle is especially preferable.

With respect to the size of the metallic particle, when the particle size is too small, the resulting thermal transfer material becomes blackish, whereby the metallic gloss is lowered. Also, when the thickness of the metallic particle is thick, the image forming layer becomes thick, too, and therefore, such is not preferable. With respect to the size and shape of the metallic particle, the thickness of the particle is preferably from 0.04 to 0.7 μm, and more preferably from 0.05 to 0.1 μm; and the particle size is preferably from 2 to 30 μm, and more preferably from 3 to 15 μm. Further, the metallic particle is preferably a tabular particle having a ratio of the thickness to the length of from 1/2 to 1/2,000, more preferably from 1/20 to 1/2,000, and especially preferably from 1/50 to 1/500.

The thermal transfer material containing the foregoing white pigment or metallic particle is used together with a thermal transfer material of a conventional process color or a special color for the formation of a multicolor image. However, the image forming layer may contain a conventional process color or special color pigment together with the metallic particle and be provided for the use.

With respect to the conventional process color or special color pigment, concretely, ones described in paragraph (0080) of JP-A-2002-337468 are employed, but it should not be construed that the invention is limited thereto.

The image forming layer can contain the following components (1) to (4) in addition to the foregoing components.

(1) Wax:

With respect to the wax, concretely, ones described in paragraph (0087) of JP-A-2002-337468 are employed, but it should not be construed that the invention is limited thereto.

(2) Plasticizer:

With respect to the plasticizer, concretely, ones described in paragraph (0090) of JP-A-2002-337468 are employed, but it should not be construed that the invention is limited thereto.

(3) Photo-Radical Generator:

As the photo-radical generator, though known photo-radical generators which are used for the initiation of photopolymerization can be used, organic compounds having an absorption peak at from 300 to 500 nm, especially from 300 to 450 nm, and more especially from 300 to 400 nm are preferable in view of the matter that the coloration is small. Specific examples thereof include active halogen compounds, active ester compounds, organic peroxides, lophine dimers, aromatic diazonium salts, aromatic iodonium salts, aromatic sulfonium salts, azinium salts, borate salts, ketals, aromatic ketones, diketones, thiols, azo compounds, and acylphosphine oxide compounds. Of these, acylphosphine oxide compounds such as bis(2,4,6-trimethylbenzoyl)-phenylphosphine oxide and 2,4,6-trimethylbenzoyldiphenylphosphine oxide are preferable.

An addition amount of the photo-radical generator is usually from 0.01 to 10 mmoles/m², and preferably from 0.1 to 1 mmoles/m².

(4) Others:

The image forming layer may further contain a surfactant, an inorganic or organic fine particle (for example, silica gel), an oil (for example, linseed oil and mineral oils), a thickener, an antistatic agent, and the like in addition to the foregoing components.

The image forming layer can be provided by preparing a coating liquid having the pigment, the binder, etc. dissolved or dispersed therein, coating this coating liquid on the light-to-heat conversion layer (in the case where the following heat-sensitive release layer is provided on the light-to-heat conversion layer, on this heat-sensitive release layer), and then drying it.

It is possible to provide, on the light-to-heat conversion layer of the thermal transfer material, a heat-sensitive release layer containing a heat-sensitive material which generates a gas by the action of heat as generated in the light-to-heat conversion layer or releases attached water, thereby weakening a bonding strength between the light-to-heat conversion layer and the image forming layer. Examples of such a heat-sensitive material which can be used include compounds (polymers or low molecular compounds) which are decomposed or denatured themselves by heat to generate a gas; and compounds (polymers or low molecular compounds) which absorb or adsorb a considerable amount of a readily volatile gas such as moisture. Such compounds can be used jointly.

With respect to the polymers which are decomposed or denatured by heat to generate a gas, concretely, ones described in paragraph (0097) of JP-A-2002-337468 are employed, but it should not be construed that the invention is limited thereto.

In the case where a low molecular compound is used as the heat-sensitive material of the heat-sensitive release layer, it is preferable that the low molecular compound is used in combination with a binder. As the binder, though polymers which are decomposed or denatured themselves by heat to generate a gas can be used, usual binders not having such properties can be used, too. It is desired that the heat-sensitive release layer covers substantially the whole of the light-to-heat conversion layer. Its thickness is in general in the range of from 0.03 to 1 μm, and preferably from 0.05 to 0.5 μm.

Incidentally, in the thermal transfer material, in place of providing an independent heat-sensitive release layer, there may be employed a construction in which the heat-sensitive material is added to a coating liquid for light-to-heat conversion layer to form a light-to-heat conversion layer, thereby making it work as both the light-to-heat conversion layer and the heat-sensitive release layer.

Next, the image receiving material (intermediate transfer medium) which can be used in combination with the thermal transfer material will be hereunder described.

Image Receiving Material

Layer Construction

The image receiving material is a construction in which one or more image receiving layers are usually provided on a support, and one or two or more layers of a cushioning layer, a release layer, and an interlayer are provided between the support and the image receiving layer, if desired. Also, it is preferable from the standpoint of traveling properties that a back layer is provided on the surface of the support opposite to the image receiving layer side.

Support

The support is not particularly limited, and examples thereof include usual sheet-form substrates such as plastics, metals, glass, resin-coated papers, papers, and various composites. Concretely, ones described in paragraph (0102) of JP-A-2002-337468 are employed, but it should not be construed that the invention is limited thereto.

A thickness of the support of the image receiving material is usually from 10 to 400 μm, and preferably from 25 to 200 μm. Also, in order to enhance adhesion to the image receiving layer (or the cushioning layer) or adhesion to the image forming layer of the thermal transfer material, the surface of the support may be subjected to a surface treatment such as a corona discharge treatment and a glow discharge treatment.

Image Receiving Layer

In order to transfer the image forming layer onto the surface of the image receiving material and fix it, it is preferred to provide one or more image receiving layers on the support. With respect to the image receiving layer, concretely, ones described in paragraph (0106) of JP-A-2002-337468 are employed, but it should not be construed that the invention is limited thereto.

Other Layers

A cushioning layer may be provided between the support and the image receiving layer. By providing a cushioning layer, it is possible to enhance adhesion between the image forming layer and the image receiving layer at the time of laser thermal transfer and to enhance the image quality. Also, even when a foreign matter is incorporated between the thermal transfer material and the image receiving material at the time of recording, a gap between the image receiving layer and the image forming layer becomes small by the deformation action of the cushioning layer. As a result, it is possible to make the size of an image defect such as deletion. Further, in the case where after transferring and forming an image, the image is transferred onto separately prepared paper for regular printing, etc., since the image surface is deformed corresponding to the uneven surface of the paper, it is possible to enhance the transfer properties of the image receiving layer. Also, by lowering the gloss of the material to be transferred, it is possible to enhance approximation properties to a printed matter.

With respect to the cushioning layer, concretely, ones described in paragraph (0112) of JP-A-2002-337468 are employed, but it should not be construed that the invention is limited thereto.

It is necessary that the image receiving layer and the cushioning layer be bonded to each other until the stage of laser recording. For the purpose of transferring the image onto paper for regular printing, the both are preferably provided in a releasable manner. In order to make the release easy, it is preferable that the release layer is provided in a thickness of from approximately 0.1 to 2 μm between the cushioning layer and the image receiving layer. When the layer thickness is too thick, a performance of the cushioning layer is hardly revealed. Therefore, it is necessary to adjust the layer thickness by the kind of the release layer.

With respect to the release layer, concretely, ones described in paragraph (0114) of JP-A-2002-337468 are employed, but it should not be construed that the invention is limited thereto.

The image receiving material to be combined with the thermal transfer material may be constructed such that the image receiving layer also works as the cushioning layer. In that case, the image receiving material may be a support/cushioning image receiving layer construction or a support/undercoat layer/cushioning image receiving layer construction. In this case, it is also preferable that the cushioning image receiving layer is provided in a releasable manner such that it can be re-transferred onto paper for regular printing. In this case, the image after re-transfer onto paper for regular printing becomes an image having excellent gloss.

A thickness of the cushioning image receiving layer is from 5 to 100 μm, and preferably from 10 to 40 μm.

Also, what a back layer is provided on the surface of the support opposite to the surface on which the image receiving layer is provided is preferable because traveling properties of the image receiving material are improved. When a surfactant, an antistatic agent such as a tin oxide fine particle, or a matting agent such as silicon oxide and a PMMA particle is added in the back layer, the traveling properties within a recording device are improved, and therefore, such is preferable.

Such an additive can be added in not only the back layer but also the image receiving layer or other layers. The kind of the additive varies depending upon the purpose and cannot be unequivocally defined. However, for example, in the case of a matting agent, a particle having a mean particle size of from 0.5 to 10 μm can be added in an amount of from approximately 0.5 to 80% in the layer. The antistatic agent can be properly selected among various surfactants and conductive agents and used such that the layer preferably has a surface resistance of not more than 10¹² Ω, more preferably not more than 10⁹ Ω under conditions at 23° C. and 50% RH.

With respect to the back layer, concretely, ones described in paragraph (0119) of JP-A-2002-337468 are employed, but it should not be construed that the invention is limited thereto.

The thermal transfer material and the image receiving material are applied for the image formation as a laminate resulting from superimposing the image forming layer of the thermal transfer material and the image receiving layer of the image receiving material.

The laminate of the thermal transfer material and the image receiving material can be formed by various methods. For example, the laminate can be easily obtained by superimposing the image forming layer of the thermal transfer material and the image receiving layer of the image receiving material and passing them between heat rollers under pressure. In this case, the heating temperature is not higher than 160° C., and preferably not higher than 130° C. Also, as another method for obtaining the laminate, the foregoing vacuum adhesion method is suitably employed, too.

### EXAMPLES

Examples of the invention will be hereunder described, but it should be construed that the invention is not limited to these Examples in any way. Incidentally, all “parts” means “parts by weight” unless otherwise indicated.

### Example 1-1

Preparation of Thermal Transfer Sheet K (Black)

Formation of Back Layer

Composition of Coating Liquid for First Back Layer

| | | |
|---|---|---|
| Aqueous dispersion of acrylic resin | 2 | parts |
| (JURYMER ET410, solids content: | | |
| 20% by weight, manufactured | | |
| by Nihon Junyaku Co., Ltd.) | | |
| Antistatic agent (aqueous | 7.0 | parts |
| dispersion of tin oxide-antimony oxide) | | |
| (mean particle size: 0.1 μm, 17% by weight) | | |
| Polyoxyethylene phenyl ether | 0.1 | parts |
| Melamine compound (SUMITEX RESIN M-3, | 0.3 | parts |
| manufactured by Sumitomo Chemical Co., Ltd.) | | |
| Distilled water | 90.6 | parts |

Formation of First Back Layer

One surface (back surface) of a 75 μm-thick biaxially stretched polyethylene terephthalate support (surface roughness Ra of the both surfaces: 0.01 μm) was subjected to a corona treatment, and the coating liquid for first back layer having the foregoing composition was coated thereon in a dry thickness of 0.03 μm and then dried at 180° C. for 30 seconds, thereby forming a first back layer.

Composition of Coating Liquid for Second Back Layer

| | | |
|---|---|---|
| Polyolefin | 3.0 | parts |
| (CHEMIPEARL S-120, 27% by weight, manufactured | | |
| by Mitsui Petrochemical Industries, Ltd.) | | |
| Antistatic agent (aqueous dispersion of | 2.0 | parts |
| tin oxide-antimony oxide) (mean particle | | |
| size: 0.1 μm, 17% by weight) | | |
| Colloidal silica | 2.0 | parts |
| (SNOWTEX C, 20% by weight, manufactured by | | |
| Nissan Chemical Industries, Ltd.) | | |
| Epoxy compound (DENACOL EX-614B, | 0.3 | parts |
| manufactured by Nagase Chemicals Ltd.) | | |
| Distilled water | 92.7 | parts |

Formation of Second Back Layer

The coating liquid for second back layer having the foregoing composition was coated on the first back layer in a dry thickness of 0.03 μm and then dried at 170° C. for 30 seconds, thereby forming a second back layer.

Formation of Light-to-Heat Conversion Layer

Preparation of Coating Liquid for Light-to-Heat Conversion Layer

The following respective components were mixed while stirring using a stirrer, thereby preparing a coating liquid for light-to-heat conversion layer.

Composition of Coating Liquid for Light-to-Heat Conversion Layer

| | |
|---|---|
| Infrared light absorbing dye having the following structure | 0.5 parts |

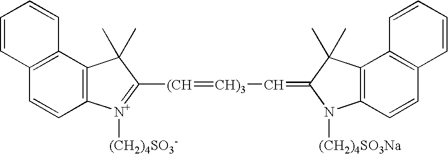

| | |
|---|---|
| Polyamide-imide resin (15% N-methylpyrrolidone solution) | 9 parts |
| (VYLOMAX HR-11N, manufactured by Toyobo Co., Ltd.) | |
| 1.5 μm-silicone particle (TOSPEARL 120, | 0.06 parts |
| manufactured by Toshiba Silicone Co., Ltd.) | |
| N-Methylpyrrolidone | 51 parts |
| Methyl ethyl ketone | 34 parts |
| Methanol | 5 parts |
| Fluorine based surfactant (30% methyl ethyl ketone solution) | 0.01 parts |
| (MEGAFAC F-780F, manufactured by Dainippon Ink and | |
| Chemicals, Incorporated) | |

Formation of Light-to-Heat Conversion Layer on the Surface of Support

The foregoing coating liquid for light-to-heat conversion layer was coated on one surface of a 75 μm-thick polyethylene terephthalate film (support) using a wire bar, and a coated material was dried in an oven at 120° C. for 2 minutes, thereby forming a light-to-heat conversion layer on the support. An optical density of the resulting light-to-heat conversion layer at a wavelength of 808 nm was measured using a UV-spectrophotometer UV-240, manufactured by Shimadzu Corporation and found to be OD=1.03. A layer thickness was measured by observing the cross-section of the light-to-heat conversion layer by a scanning electron microscope and found to be 0.3 μm in average.

Formation of Image Forming Layer

Preparation of Coating Liquid for Black Image Forming Layer

The following respective components were charged in a mill of a kneader, and a shear force was applied while adding a small amount of a solvent, thereby achieving a dispersion pre-treatment. The solvent was further added to the resulting dispersion so as to ultimately have the following composition, and the mixture was subjected to sand mill dispersion for 2 hours, thereby obtaining a pigment dispersion mother liquor.

Composition of Black Pigment Dispersion Mother Liquor

Composition 1:

| | | |
|---|---|---|
| Polyvinyl butyral (S-LEC B BL-SH, | 12.6 | parts |
| manufactured by Sekisui Chemical Co., Ltd.) | | |
| Pigment Black 7 | 4.5 | parts |
| (MITSUBISHI CARBON BLACK #5, manufactured | | |
| by Mitsubishi Chemical Corporation, PVC | | |
| blackness: 1) | | |
| Dispersing agent | 0.8 | parts |
| (SOLSPERSE S-20000, manufactured by ICI) | | |
| n-Propyl alcohol | 79.4 | parts |

Composition of Black Pigment Dispersion Mother Liquor

Composition 2:

| | | |
|---|---|---|
| Polyvinyl butyral (S-LEC B BL-SH, | 12.6 | parts |
| manufactured by Sekisui Chemical Co., Ltd.) | | |
| Pigment Black 7 | 10.5 | parts |
| (MITSUBISHI CARBON BLACK MA100, manufactured | | |
| by Mitsubishi Chemical Corporation, PVC | | |
| blackness: 10) | | |
| Dispersing agent | 0.8 | parts |
| (SOLSPERSE S-20000, manufactured by ICI) | | |
| n-Propyl alcohol | 79.4 | parts |

Next, the following components were mixed while stirring using a stirrer, thereby preparing a coating liquid for black image forming layer.

Composition of Coating Liquid for Black Image Forming Layer

| | | |
|---|---|---|
| Black pigment dispersion mother liquors as | 185.7 | parts |
| described above (Composition 1)/(Composition | | |
| 2) = 70/30 (parts) | | |
| Polyvinyl butyral (S-LEX B BL-SH, | 11.9 | parts |
| manufactured by Sekisui Chemical Co., Ltd.) | | |
| Wax based compounds: | | |
| (Stearic acid amide, “NEWTRON 2”, | 1.7 | parts |
| manufactured by Nippon Fine Chemical Co., Ltd.) | | |
| (Behenic acid amide, “DIAMID BM”, | 1.7 | parts |
| manufactured by Nippon Kasei Chemical Co., Ltd.) | | |
| (Lauric acid amide, “DIAMID Y”, | 1.7 | parts |
| manufactured by Nippon Kasei Chemical Co., Ltd.) | | |
| (Palmitic acid amide, “DIAMID KP”, | 1.7 | parts |
| manufactured by Nippon Kasei Chemical Co., Ltd.) | | |
| (Erucic acid amide, “DIAMID L-200”, | 1.7 | parts |
| manufactured by Nippon Kasei Chemical Co., Ltd.) | | |
| (Oleic amide, “DIAMID O-200”, | 1.7 | parts |
| manufactured by Nippon Kasei Chemical Co., Ltd.) | | |
| Rosin (KE-311, manufactured by | 11.4 | parts |
| Arakawa Chemical Industries, Ltd.) | | |
| Fluorine based surfactant (30% methyl ethyl | 2.1 | parts |
| ketone solution) (MEGAFAC F-780F, manufactured | | |
| by Dainippon Ink and Chemicals, Incorporated) | | |
| Colloidal silica (30% methyl ethyl ketone | 7.1 | parts |
| dispersion) (MEK-ST, manufactured by Nissan | | |
| Chemical Industries, Ltd.) | | |
| n-Propyl alcohol | 1,050 | parts |
| Methyl ethyl ketone | 295 | parts |

Formation of Black Image Forming Layer on the Surface of Light-to-Heat Conversion Layer

The foregoing coating liquid for black image forming layer was coated on the surface of the foregoing light-to-heat conversion layer using a wire bar for one minute, and a coated material was dried in an oven at 100° C. for 2 minutes, thereby forming a black image forming layer on the light-to-heat conversion layer. The image forming layer of the resulting thermal transfer sheet had a thickness of 0.60 μm.

By the foregoing steps, there was prepared a thermal transfer sheet comprising a support having thereon a light-to-heat conversion layer and a black image forming layer in this order (this thermal transfer sheet will be hereinafter referred to as “thermal transfer sheet K”; similarly, a thermal transfer sheet having a yellow image forming layer provided thereon will be hereinafter referred to as “thermal transfer sheet Y”, a thermal transfer sheet having a magenta image forming layer provided thereon will be hereinafter referred to as “thermal transfer sheet M”, a thermal transfer sheet having a cyan image forming layer provided thereon will be hereinafter referred to as “thermal transfer sheet C”, a thermal transfer sheet having a white image forming layer provided thereon will be hereinafter referred to as “thermal transfer sheet W”, and a thermal transfer sheet having a metallically glossy image forming layer provided thereon will be hereinafter referred to as “thermal transfer sheet S”, respectively).

Preparation of Thermal Transfer Sheet Y

A thermal transfer sheet Y was prepared in the same manner as in the preparation of the thermal transfer sheet K, except that in the preparation of the foregoing thermal transfer sheet K, a coating liquid for yellow image forming layer having the following composition was used in place of the coating liquid for black image forming layer. The image forming layer of the resulting thermal transfer sheet Y had a thickness of 0.42 μm.

Composition of Yellow Pigment Dispersion Mother Liquor

Composition 1 of Yellow Pigment:

| | | |
|---|---|---|
| Polyvinyl butyral (S-LEC B BL-SH, | 7.1 | parts |
| manufactured by Sekisui Chemical Co., Ltd.) | | |
| Pigment Yellow 180 (NOVOPERM YELLOW P-HG, | 12.9 | parts |
| manufactured by Clariant (Japan) K.K.) | | |
| Dispersing agent | 0.6 | parts |
| (SOLSPERSE S-20000, manufactured by ICI) | | |
| n-Propyl alcohol | 79.4 | parts |

Composition of Yellow Pigment Dispersion Mother Liquor

Composition 2 of Yellow Pigment:

| | | |
|---|---|---|
| Polyvinyl butyral (S-LEC B BL-SH, | 7.1 | parts |
| manufactured by Sekisui Chemical Co., Ltd.) | | |
| Pigment Yellow 139 (NOVOPERM YELLOW M2R 70, | 12.9 | parts |
| manufactured by Clariant (Japan) K.K.) | | |
| Dispersing agent | 0.6 | parts |
| (SOLSPERSE S-20000, manufactured by ICI) | | |
| n-Propyl alcohol | 79.4 | parts |

Composition of Coating Liquid for Yellow Image Forming Layer

| | | |
|---|---|---|
| Yellow pigment dispersion mother liquors as | 126 | parts |
| described above (Composition 1 of yellow | | |
| pigment)/(Composition 2 of yellow | | |
| pigment) = 95/5 (parts) | | |
| Polyvinyl butyral (S-LEX B BL-SH, | 4.6 | parts |
| manufactured by Sekisui Chemical Co., Ltd.) | | |
| Wax based compounds: | | |
| (Stearic acid amide, “NEWTRON 2”, | 0.7 | parts |
| manufactured by Nippon Fine Chemical Co., Ltd.) | | |
| (Behenic acid amide, “DIAMID BM”, | 0.7 | parts |
| manufactured by Nippon Kasei Chemical Co., Ltd.) | | |
| (Lauric acid amide, “DIAMID Y”, | 0.7 | parts |
| manufactured by Nippon Kasei Chemical Co., Ltd.) | | |
| (Palmitic acid amide, “DIAMID KP”, | 0.7 | parts |
| manufactured by Nippon Kasei Chemical Co., Ltd.) | | |
| (Erucic acid amide, “DIAMID L-200”, | 0.7 | parts |
| manufactured by Nippon Kasei Chemical Co., Ltd.) | | |
| (Oleic amide, “DIAMID O-200”, | 0.7 | parts |
| manufactured by Nippon Kasei Chemical Co., Ltd.) | | |
| Nonionic surfactant (CHEMISTAT 1100, | 0.4 | parts |
| manufactured by Sanyo Chemical Industries, Ltd.) | | |
| Rosin (KE-311, manufactured by | 2.4 | parts |
| Arakawa Chemical Industries, Ltd.) | | |
| Fluorine based surfactant (30% methyl ethyl | 0.8 | parts |
| ketone solution) (MEGAFAC F-780F, manufactured | | |
| by Dainippon Ink and Chemicals, Incorporated) | | |
| n-Propyl alcohol | 793 | parts |
| Methyl ethyl ketone | 198 | parts |

Preparation of Thermal Transfer Sheet M

A thermal transfer sheet M was prepared in the same manner as in the preparation of the thermal transfer sheet K, except that in the preparation of the foregoing thermal transfer sheet K, a coating liquid for magenta image forming layer having the following composition was used in place of the coating liquid for black image forming layer. The image forming layer of the resulting thermal transfer sheet M had a thickness of 0.38 μm.

Composition of Magenta Pigment Dispersion Mother Liquor

Composition 1 of Magenta Pigment:

| | | |
|---|---|---|
| Polyvinyl butyral (DENAK BUTYRAL #2000-L, | 12.6 | parts |
| manufactured by Denki Kagaku Kogyo Kabushiki | | |
| Kaisha) | | |
| Pigment Red 57:1 (SYMULER BRILLIANT CARMINE | 15.0 | parts |
| 6B-229, manufactured by Dainippon Ink and | | |
| Chemicals, Incorporated) | | |
| Dispersing agent | 0.6 | parts |
| (SOLSPERSE S-20000, manufactured by ICI) | | |
| n-Propyl alcohol | 80.4 | parts |

Composition of Magenta Pigment Dispersion Mother Liquor

Composition 2 of Magenta Pigment:

| | | |
|---|---|---|
| Polyvinyl butyral | 12.6 | parts |
| (DENAK BUTYRAL #2000-L, | | |
| manufactured by Denki Kagaku | | |
| Kogyo Kabushiki Kaisha) | | |
| Pigment Red 57:1 (LIONOL RED 6B-4290G, | 15.0 | parts |
| manufactured by Toyo Ink Mfg. Co., Ltd.) | | |
| Dispersing agent | 0.6 | parts |
| (SOLSPERSE S-20000, manufactured by ICI) | | |
| n-Propyl alcohol | 79.4 | parts |

Composition of Coating Liquid for Magenta Image Forming Layer

| | | |
|---|---|---|
| Magenta pigment dispersion mother liquors as | 163 | parts |
| described above (Composition 1 of magenta | | |
| pigment)/(Composition 2 of magenta | | |
| pigment) = 95/5 (parts) | | |
| Polyvinyl butyral (DENAK BUTYRAL #2000-L, | 4.0 | parts |
| manufactured by Denki Kagaku Kogyo Kabushiki | | |
| Kaisha) | | |
| Wax based compounds: | | |
| (Stearic acid amide, “NEWTRON 2”, | 1.0 | part |
| manufactured by Nippon Fine Chemical Co., Ltd.) | | |
| (Behenic acid amide, “DIAMID BM”, | 1.0 | part |
| manufactured by Nippon Kasei Chemical Co., Ltd.) | | |
| (Lauric acid amide, “DIAMID Y”, | 1.0 | part |
| manufactured by Nippon Kasei Chemical Co., Ltd.) | | |
| (Palmitic acid amide, “DIAMID KP”, | 1.0 | part |
| manufactured by Nippon Kasei Chemical Co., Ltd.) | | |
| (Erucic acid amide, “DIAMID L-200”, | 1.0 | part |
| manufactured by Nippon Kasei Chemical Co., Ltd.) | | |
| (Oleic amide, “DIAMID O-200”, | 1.0 | part |
| manufactured by Nippon Kasei Chemical Co., Ltd.) | | |
| Nonionic surfactant (CHEMISTAT 1100, | 0.7 | parts |
| manufactured by Sanyo Chemical Industries, Ltd.) | | |
| Rosin (KE-311, manufactured by | 4.6 | parts |
| Arakawa Chemical Industries, Ltd.) | | |
| Pentaerythritol tetraacrylate (NK ESTER A-TMMT, | 2.5 | parts |
| Manufactured by Shin-Nakamura Chemical Co., Ltd.) | | |
| Fluorine based surfactant (30% methyl ethyl | 1.3 | parts |
| ketone solution) (MEGAFAC F-780F, manufactured | | |
| by Dainippon Ink and Chemicals, Incorporated) | | |
| n-Propyl alcohol | 848 | parts |
| Methyl ethyl ketone | 246 | parts |

Preparation of Thermal Transfer Sheet C

A thermal transfer sheet C was prepared in the same manner as in the preparation of the thermal transfer sheet K, except that in the preparation of the foregoing thermal transfer sheet K, a coating liquid for cyan image forming layer having the following composition was used in place of the coating liquid for black image forming layer. The image forming layer of the resulting thermal transfer sheet C had a thickness of 0.45 μm.

Composition of Cyan Pigment Dispersion Mother Liquor

Composition 1 of Cyan Pigment:

| | | |
|---|---|---|
| Polyvinyl butyral (S-LEC B BL-SH, | 12.6 | parts |
| manufactured by Sekisui Chemical Co., Ltd.) | | |
| Pigment Blue 15:4 (CYANINE BLUE 700-10FG, | 15.0 | parts |
| manufactured by Toyo Ink Mfg. co., Ltd.) | | |
| Dispersing agent (PW-36, manufactured by | 0.8 | parts |
| Kusumoto Chemicals, Ltd.) | | |
| n-Propyl alcohol | 110 | parts |

Composition of Cyan Pigment Dispersion Mother Liquor

Composition 2 of Cyan Pigment:

| | | |
|---|---|---|
| Polyvinyl butyral (S-LEC B BL-SH, | 12.6 | parts |
| manufactured by Sekisui Chemical Co., Ltd.) | | |
| Pigment Blue 15 (LIONOL BLUE 7027, | 5.0 | parts |
| manufactured by Toyo Ink Mfg. Co., Ltd.) | | |
| Dispersing agent (PW-36, manufactured by | 0.8 | parts |
| Kusumoto Chemicals, Ltd.) | | |
| n-Propyl alcohol | 110 | parts |

Composition of Coating Liquid for Cyan Image Forming Layer

| | | |
|---|---|---|
| Cyan pigment dispersion mother liquors as | 118 | parts |
| described above (Composition 1 of cyan | | |
| pigment)/(Composition 2 of cyan pigment) = | | |
| 90/10 (parts) | | |
| Polyvinyl butyral (S-LEC B BL-SH, | 5.2 | parts |
| manufactured by Sekisui Chemical Co., Ltd.) | | |
| Inorganic Pigment, “MEK-ST” | 1.3 | parts |
| Wax based compounds: | | |
| (Stearic acid amide, “NEWTRON 2”, | 1.0 | part |
| manufactured by Nippon Fine Chemical Co., Ltd.) | | |
| (Behenic acid amide, “DIAMID BM”, | 1.0 | part |
| manufactured by Nippon Kasei Chemical Co., Ltd.) | | |
| (Lauric acid amide, “DIAMID Y”, | 1.0 | part |
| manufactured by Nippon Kasei Chemical Co., Ltd.) | | |
| (Palmitic acid amide, “DIAMID KP”, | 1.0 | part |
| manufactured by Nippon Kasei Chemical Co., Ltd.) | | |
| (Erucic acid amide, “DIAMID L-200”, | 1.0 | part |
| manufactured by Nippon Kasei Chemical Co., Ltd.) | | |
| (Oleic amide, “DIAMID O-200”, | 1.0 | part |
| manufactured by Nippon Kasei Chemical Co., Ltd.) | | |
| Rosin (KE-311, manufactured by | 2.8 | parts |
| Arakawa Chemical Industries, Ltd.) | | |
| Pentaerythritol tetraacrylate (NK ESTER A-TMMT, | 1.7 | parts |
| Manufactured by Shin-Nakamura Chemical Co., Ltd.) | | |
| Fluorine based surfactant (30% methyl ethyl | 1.7 | parts |
| ketone solution) (MEGAFAC F-780F, manufactured | | |
| by Dainippon Ink and Chemicals, Incorporated) | | |
| n-Propyl alcohol | 890 | parts |
| Methyl ethyl ketone | 247 | parts |

Preparation of Thermal Transfer Sheet W

A thermal transfer sheet W was prepared in the same manner as in the preparation of the thermal transfer sheet K, except that in the preparation of the foregoing thermal transfer sheet K, a coating liquid for white image forming layer having the following composition was used in place of the coating liquid for black image forming layer. The image forming layer of the resulting thermal transfer sheet W had a thickness of 1.5 μm.

Composition of White Pigment Dispersion Mother Liquor

| | | |
|---|---|---|
| Polyvinyl butyral (S-LEC B BL-SH, | 6.3 | parts |
| manufactured by Sekisui Chemical Co., Ltd.) | | |
| Titanium dioxide particle | 28.0 | parts |
| (JR805, manufactured by Tayca Corporation) | | |
| Dispersing agent | 1.5 | parts |
| (SOLSPERSE S-20000, manufactured by ICI) | | |
| n-Propyl alcohol | 65 | parts |

Composition of Coating Liquid for White Image Forming Layer

| | | |
|---|---|---|
| White pigment dispersion mother liquor as | 26 | parts |
| described above | | |
| Wax based compounds: | | |
| (Stearic acid amide, “NEWTRON 2”, | 0.1 | parts |
| manufactured by Nippon Fine Chemical Co., Ltd.) | | |
| (Behenic acid amide, “DIAMID BM”, | 0.1 | parts |
| manufactured by Nippon Kasei Chemical Co., Ltd.) | | |
| (Lauric acid amide, “DIAMID Y”, | 0.1 | parts |
| manufactured by Nippon Kasei Chemical Co., Ltd.) | | |
| (Palmitic acid amide, “DIAMID KP”, | 0.1 | parts |
| manufactured by Nippon Kasei Chemical Co., Ltd.) | | |
| (Erucic acid amide, “DIAMID L-200”, | 0.1 | parts |
| manufactured by Nippon Kasei Chemical Co., Ltd.) | | |
| (Oleic amide, “DIAMID O-200”, | 0.1 | parts |
| manufactured by Nippon Kasei Chemical Co., Ltd.) | | |
| Rosin (KE-311, manufactured by | 1.7 | parts |
| Arakawa Chemical Industries, Ltd.) | | |
| Fluorine based surfactant (30% methyl ethyl | 0.3 | parts |
| ketone solution) (MEGAFAC F-780F, manufactured | | |
| by Dainippon Ink and Chemicals, Incorporated) | | |
| Fluorescent whitener: Benzoxazole derivative | 0.03 | parts |
| (UVITEX-OB, manufactured by Ciba-Geigy AG) | | |
| n-Propyl alcohol | 54 | parts |
| Methyl ethyl ketone | 17 | parts |

Preparation of Thermal Transfer Sheet S

A thermal transfer sheet S was prepared in the same manner as in the preparation of the thermal transfer sheet K, except that in the preparation of the foregoing thermal transfer sheet K, a coating liquid for metallically glossy image forming layer having the following composition was used in place of the coating liquid for black image forming layer. The image forming layer of the resulting thermal transfer sheet S had a thickness of 1.0 μm.

Composition of Coating Liquid for Metallically Glossy Image Forming Layer

| | | |
|---|---|---|
| Polyvinyl butyral (S-LEC B BL-SH, | 3.2 | parts |
| manufactured by Sekisui Chemical Co., Ltd.) | | |
| Aluminum paste (60%) (AM1501, | 4.2 | parts |
| manufactured by Asahi Kasei Corporation) | | |
| Fatty acid amide (20% solution) (PFA230, | 4.1 | parts |
| manufactured by Kusumoto Chemicals, Ltd.) | | |
| Wax based compounds: | | |
| (Stearic acid amide, “NEWTRON 2”, | 0.2 | parts |
| manufactured by Nippon Fine Chemical Co., Ltd.) | | |
| (Behenic acid amide, “DIAMID BM”, | 0.2 | parts |
| manufactured by Nippon Kasei Chemical Co., Ltd.) | | |
| (Lauric acid amide, “DIAMID Y”, | 0.2 | parts |
| manufactured by Nippon Kasei Chemical Co., Ltd.) | | |
| (Palmitic acid amide, “DIAMID KP”, | 0.2 | parts |
| manufactured by Nippon Kasei Chemical Co., Ltd.) | | |
| (Erucic acid amide, “DIAMID L-200”, | 0.2 | parts |
| manufactured by Nippon Kasei Chemical Co., Ltd.) | | |
| (Oleic amide, “DIAMID O-200”, | 0.2 | parts |
| manufactured by Nippon Kasei Chemical Co., Ltd.) | | |
| Rosin ester (KE-311, manufactured by | 0.7 | parts |
| Arakawa Chemical Industries, Ltd.) | | |
| Fluorine based surfactant (30% methyl ethyl | 0.3 | parts |
| ketone solution) (MEGAFAC F-780F, manufactured | | |
| by Dainippon Ink and Chemicals, Incorporated) | | |
| n-Propyl alcohol | 67 | parts |
| Methyl ethyl ketone | 20 | parts |

Preparation of Image Receiving Sheet

A coating liquid for cushioning layer having the following composition and a coating liquid for image receiving layer having the following composition were prepared.

Coating Liquid for Cushioning Layer

| | | |
|---|---|---|
| Vinyl chloride-vinyl acetate copolymer | 20 | parts |
| (MPR-TSL, manufactured by Nissin Chemical | | |
| Industry Co., Ltd.) | | |
| Polyester plasticizer (PARAPLEX G-40, | 10 | parts |
| manufactured by CP. HALL. COMPANY) | | |
| Fluorine based surfactant (MEGAFAC F-177, | 0.5 | parts |
| manufactured by Dainippon Ink and Chemicals, | | |
| Incorporated) | | |
| Methyl ethyl ketone | 60 | parts |
| Toluene | 10 | parts |
| N,N-Dimethylformamide | 3 | parts |

Coating Liquid for Image Receiving Layer

| | | |
|---|---|---|
| Polyvinyl butyral (S-LEC B BL-1, | 5.8 | parts |
| manufactured by Sekisui Chemical Co., Ltd.) | | |
| Styrene-maleic acid copolymer half ester | 3.1 | parts |
| (OXILAC SH128, manufactured by Nippon | | |
| Shokubai Co., Ltd.) | | |
| Antistatic agent (CHEMISTAT 3033, | 0.16 | parts |
| manufactured by Sanyo Chemical Industries, Ltd.) | | |
| Fluorine based surfactant (30% methyl ethyl | 0.08 | parts |
| ketone solution) (MEGAFAC F-780F, manufactured | | |
| by Dainippon Ink and Chemicals, Incorporated) | | |
| n-Propyl alcohol | 13 | parts |
| Methanol | 46 | parts |
| 1-Methoxy-2-propanol | 31 | parts |

Using a small-width coating machine, the foregoing coating liquid for cushioning layer was coated on a white PET support (LUMIRROR #130E58, manufactured by Toray Industries, Inc., thickness: 130 μm), and a coated layer was dried. Next, the coating liquid for image receiving layer was coated and then dried. The coating amounts were adjusted such that the thickness after drying of the cushioning layer was about 16 μm and that the thickness after drying of the image receiving layer was about 3 μm. The white PET support is a void-containing plastic support composed of a laminate (total thickness: 130 μm, specific gravity: 0.8) of a void-containing polyethylene terephthalate layer (thickness: 116 μm, porosity: 20%) having a titanium oxide-containing polyethylene terephthalate layer (thickness: 7 μm, content of titanium oxide: 2%) provided on the both surfaces thereof.

Formation of Transferred Image

Using Luxel FINALPROOF 5600 as a recording device, a transferred image was obtained on the image receiving sheet in the following manner. Incidentally, the image size is 515 mm×728 mm, and the resolution of image is 2,600 dpi.

The above-prepared image receiving material (56 cm×79 cm) was wound around a rotary drum having a diameter of 38 cm and provided with vacuum section holes having a diameter of 1 mm (surface density: one per an area of 3 cm×8 cm) and vacuum absorbed thereon. Next, the foregoing thermal transfer material K having been cut into a size of 61 cm×84 cm was superimposed thereon such that it was protruded from the image receiving material and intimately contacted and laminated such that air was sucked into the section holes, while squeezing by squeeze rolls. The degree of value in the state that the section holes were plugged was −150 mm Hg (=81.13 kPa) based on one atmosphere. The drum was rotated, semi-conductor laser beams having a wavelength of 808 nm were irradiated on the surface of the laminate on the drum from the outside such that they were condensed into a spot of 7 μm on the surface of the light-to-heat conversion layer, and an image was recorded on the laminate by laser while moving in the rectangular direction (sub-scanning) against the rotation direction (major scanning direction) of the rotary drum. The laser irradiation condition is as follows. Also, laser beams composed of a multi-beam secondary alignment of five rows of parallelograms in the major scanning direction and three rows of parallelograms in the sub-scanning direction were used as the laser beams as used in this Example.

| | | |
|---|---|---|
| Laser power: | 110 | mW |
| Number of revolution of drum: | 380 | rpm |
| Sub-scanning pitch: | 6.35 | μm |
| Environmental temperature | 23° | C., |
| and relative humidity: | 50 | RH % |

The diameter of the exposure drum is preferably 360 mm or more, and concretely, one having a diameter of 380 mm was used.

The laminate which had been completed for laser recording using the thermal transfer sheet K was taken off from the drum, and the thermal transfer sheet K was peeled apart from the image receiving sheet by using fingers. As a result, it was confirmed that only the light-irradiated region of the image forming layer of the thermal transfer sheet K was transferred onto the image receiving sheet from the thermal transfer sheet K.

Images of five colors were successively transferred onto the image sheet from each thermal transfer sheet of the foregoing thermal transfer sheet C, thermal transfer sheet M, thermal transfer sheet Y and thermal transfer sheet W in the same manner as described above.

Preparation of Readily Adhesive Layer-Provided Release Paper

A hot-melt adhesive (HIRODINE 7573, manufactured by Hirodine Corp.) was subjected to hot-melt extrusion in a thickness of 30 μm onto GLASSINE SEPA 70GS8 (release paper, manufactured by Oji Paper Co., Ltd.), thereby obtaining readily adhesive layer-provided release paper. The readily adhesive layer had a rigid pendulum attenuation factor at 23° C. of 0.055 and a rigid pendulum attenuation factor at 90° C. of 0.23. Also, the readily adhesive layer had a Vicat softening point of 60° C. Also, the surface of the release paper in the contact side with the readily adhesive layer had an Rz of 6.5 μm.

Transfer of Readily Adhesive Layer onto Transparent Support (Final Medium to be Transferred)

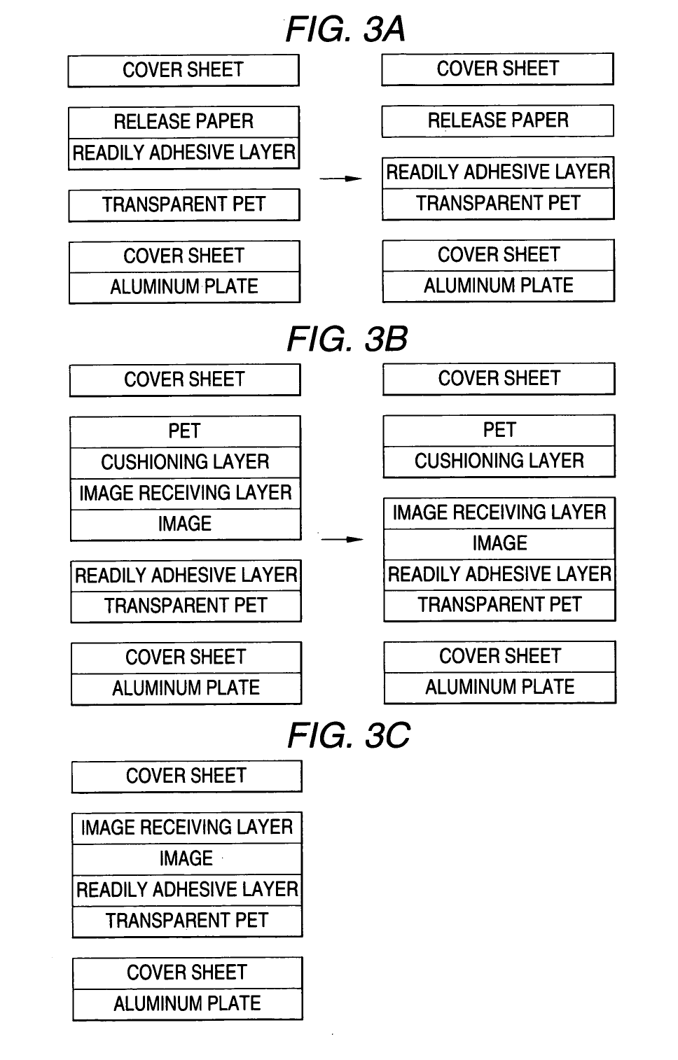

The foregoing readily adhesive layer-provided release paper was superimposed on a 50 μm-thick PET film. Further, the both sides of the laminate were sandwiched by a cover sheet (surface-treated polyester sheet having a surface Rz of 0.15 μm and a coefficient of static friction against the surface of the image receiving sheet of 0.27; CERAPEARL #100S, manufactured by Toyo Metallizing Co., Ltd.). Moreover, an aluminum plate having a thickness of 1 mm was superimposed in the lower side, and the resulting laminate was processed by a laminator (FL760T EXTRA, manufactured by Fuji Photo Film Co., Ltd.) (heating temperature: 125° C., pressurizing pressure: 4.5 N/cm). Thereafter, the release paper of the readily adhesive layer-provided release paper was peeled apart, thereby forming a readily adhesive layer on the transparent PET (see FIG. 3A).

The surface of the transferred readily adhesive layer had a surface Rz of 6.2 μm and a coefficient of static friction against the surface of the image receiving sheet of 1.0.

Re-Transfer of Image and Image Receiving Layer onto Readily Adhesive Layer-Provided Transparent Support

The above-obtained readily adhesive layer-provided support and the foregoing image-recorded image receiving sheet were superimposed. Further, the both sides of the laminate were sandwiched by a cover sheet (surface-treated polyester sheet having a surface Rz of 0.15 μm and a coefficient of static friction against the surface of the image receiving sheet of 0.27; CERAPEARL #100S, manufactured by Toyo Metallizing Co., Ltd.). Moreover, an aluminum plate having a thickness of 1 mm was superimposed in the lower side, and the resulting laminate was processed by a laminator (FL760T EXTRA, manufactured by Fuji Photo Film Co., Ltd.) (heating temperature: 125° C., pressurizing pressure: 4.5 N/cm). Thereafter, peeling was achieved between the cushioning layer and the image receiving layer of the image receiving sheet, thereby re-transferring the image and the image receiving layer onto the readily adhesive layer-provided transparent support (see FIG. 3B).

Smoothening Treatment

The both sides of the above-obtained material in which the image and the image receiving layer had been transferred onto the readily adhesive layer-provided transparent support were sandwiched by a cover sheet (surface-treated polyester sheet having a surface Rz of 0.15 μm and a coefficient of static friction against the surface of the image receiving sheet of 0.27; CERAPEARL #100S, manufactured by Toyo Metallizing Co., Ltd.). Moreover, an aluminum plate having a thickness of 1 mm was superimposed in the lower side, and the resulting laminate was processed by a laminator (FL760T EXTRA, manufactured by Fuji Photo Film Co., Ltd.) (heating temperature: 125° C., pressurizing pressure: 4.5 N/cm) (FIG. 3C).

By the smoothening treatment, the glossiness of the surface of the image receiving layer in a non-image area (glossiness at a light receiving angle of 60° against the sample surface) changed from 30 to 100. Also, a color image with high image quality including a white color could be formed on the transparent support. Further, the transparency of the non-image area was high, and the image strength against scratching, etc. was strong. Moreover, neither traveling failures nor the generation of a wrinkle was observed at the time of lamination.

### Example 1-2

In Example 1-1, the readily adhesive layer-provided release paper was replaced by one having an Rz in the contact side with the readily adhesive layer of the release paper of 0.7 μm.

### Example 1-3

In Example 1-1, the readily adhesive layer-provided release paper was replaced by one having an Rz in the contact side with the readily adhesive layer of the release paper of 12 μm.

### Example 1-4

In Example 1-1, the cover sheet was not used at the time of re-transfer of the image and the image receiving layer.

### Example 1-5

In Example 1-1, the cover sheet to be used in the smoothening treatment was replaced by a non-surface-treated PET base. The PET base as used had an Rz of 0.15 μm and a coefficient of static friction against the image receiving sheet of 1.4.

### Example 1-6

In Example 1-1, the readily adhesive layer-provided transparent support was replaced by MELINEX 746 (manufactured by Teijin Limited) which is a 50 μm-thick PET having been previously provided with a readily adhesive layer. The readily adhesive layer had a rigid pendulum attenuation factor at 23° C. of 0.019 and a rigid pendulum attenuation factor at 90° C. of 0.03 and had a surface Rz of 1.1 μm.

### Example 1-7

In Example 1-1, the thermal transfer sheet W was replaced by the metallically glossy thermal transfer sheet S.

### Comparative Example 1-1

In Example 1-1, the readily adhesive layer was not provided on the transparent support of the final medium to be transferred.

### Comparative Example 1-2

In Example 1-1, the smoothening treatment was not carried out.

Evaluation Methods and Evaluation Results

Each of the foregoing Examples and Comparative Examples was evaluated in the following manners. The results are shown in Table 1.

1. Adhesion strength of image and image receiving layer to transparent support:

The transparent support was folded ten times such that the image and the image receiving layer were positioned externally, and peeling of the image or image receiving layer was evaluated by visual observation.

A: Peeling was not generated.

B: Peeling was generated by folding 5 to 10 times.

C: Peeling was generated by folding 1 to 4 times.

2. Generation of wrinkle:

The image was confirmed and evaluated by visual observation.

A: No problem occurred.

B: Uneven gloss was seen on the surface. The image did not change.

C: The image was warped in some portion.

3. Transparency:

The completed sheet was superimposed on wood-free paper in which 10-point characters had been written, and whether or not the characters in a non-image area could be seen was examined.

A: The characters could be read.

B: The characters were hardly read.

C: The characters could not be read at all.

TABLE 1

| | | | | At the time | | | | | |
|---|---|---|---|---|---|---|---|---|---|
| | Readily adhesive layer | | | of | Smoothening treatment | | | | |
| | Pendulum | Pendulum | Surface Rz | re-transfer | | Coefficient | | | |
| | attenuation | attenuation | (Before | Presence or | | of static | Evaluation | | |
| | factor | factor | smoothening | absence of | Presence | friction of | Adhesion | | Trans- |
| | (at 23° C.) | (at 90° C.) | treatment) | cover sheet | or absence | cover sheet | strength | Wrinkle | parency |
| Example 1-1 | 0.055 | 0.23 | 6.2 μm | Yes | Yes | 0.27 | A | A | A |
| Example 1-2 | 0.055 | 0.23 | 0.6 μm | Yes | Yes | 0.27 | A | B | A |
| Example 1-3 | 0.055 | 0.23 | 11 μm | Yes | Yes | 0.27 | B | A | A |
| Example 1-4 | 0.055 | 0.23 | 6.2 μm | No | Yes | 0.27 | A | B | A |
| Example 1-5 | 0.055 | 0.23 | 6.2 μm | Yes | Yes | 1.4 | A | B | A |
| Example 1-6 | 0.019 | 0.03 | 1.1 μm | Yes | Yes | 0.27 | B | A | A |
| Example 1-7 | 0.055 | 0.23 | 6.2 μm | Yes | Yes | 0.27 | A | A | A |
| Comparative | | Nil | | Yes | Yes | 0.27 | C | A | A |
| Example 1-1 | | | | | | | | | |
| Comparative | 0.055 | 0.23 | 6.2 μm | Yes | No | 0.27 | A | A | C |
| Example 1-2 | | | | | | | | | |

### Example 2-1

Thermal transfer sheet K, thermal transfer sheet Y, thermal transfer sheet M, thermal transfer sheet C, thermal transfer sheet W, thermal transfer sheet S and image receiving sheet were prepared in the same ways as in Example 1-1, further transferred image was also formed in the same way as in Example 1-1.

Re-Transfer of Image and Image Receiving Layer onto Readily Adhesive Layer-Provided Transparent Support (Fine Medium to be Transferred)

A 50 μm-thick readily adhesive layer-provided transparent support (YL-A, manufactured by Unitika Ltd.) and the foregoing image-recorded image receiving sheet were superimposed. Further, the both sides of the laminate were sandwiched by a cover sheet (surface-treated polyester sheet having a surface Rz of 0.15 μm and a coefficient of static friction against the surface of the image receiving sheet of 0.27; CERAPEARL #100S, manufactured by Toyo Metallizing Co., Ltd.). Moreover, an aluminum plate having a thickness of 1 mm was superimposed in the lower side, and the resulting laminate was processed by a laminator (FL760T EXTRA, manufactured by Fuji Photo Film Co., Ltd.) (heating temperature: 125° C., pressurizing pressure: 4.5 N/cm). Thereafter, peeling was achieved between the cushioning layer and the image receiving layer of the image receiving sheet, thereby re-transferring the image and the image receiving layer onto the readily adhesive layer-provided transparent support (see FIG. 3B).

The “YL-A” transparent support was polyethylene terephthalate and had a surface Rz of the readily adhesive layer of 1.6 μm and a coefficient of static friction against the image receiving sheet of 0.7. Also, it had a rigid pendulum attenuation factor at 23° C. of 0.029.

Thus, a color image with high image quality including a white color could be formed on the transparent final medium to be transferred. The transparency of the non-image area was high, and the image strength against scratching, etc. was strong. Also, neither traveling failures nor the generation of a wrinkle was observed at the time of lamination.

### Example 2-2

In Example 2-1, the readily adhesive layer-provided transparent support was replaced by UV-C, manufactured by Unitika Ltd.

The “UV-C” transparent support was polyethylene terephthalate and had a surface Rz of the readily adhesive layer of 0.7 μm and a coefficient of static friction against the image receiving sheet of 0.6. Also, it had a rigid pendulum attenuation factor at 23° C. of 0.019.

### Example 2-3

In Example 2-1, the readily adhesive layer-provided transparent support was replaced by one as prepared by the following manner.

Preparation of Readily Adhesive Layer-Provided Transparent Support

A coating liquid for readily adhesive layer having the following composition was coated on a 50 μm-thick transparent PET film and then dried, thereby forming a readily adhesive layer having a thickness of 0.3 μm. The readily adhesive layer had a surface Rz of 1.7 μm and a coefficient of static friction against the image receiving sheet of 0.5. Also, it had a rigid pendulum attenuation factor at 23° C. of 0.021.

Composition of Coating Liquid for Readily Adhesive Layer

| | | |
|---|---|---|
| Aqueous polyurethane resin (HYDRAN AP40, | 10 | parts |
| manufactured by Dainippon Ink and Chemicals, | | |
| Incorporated) | | |
| PMMA particle having a mean particle size of | 0.04 | parts |
| 3 μm (MX300, manufactured by Soken Chemical & | | |
| Engineering Co., Ltd.) | | |
| Water | 90 | parts |

### Example 2-4

In Example 2-1, the readily adhesive layer-provided transparent support was replaced by one as prepared by the following manner.

Preparation of Readily Adhesive Layer-Provided Transparent Support

A coating liquid for readily adhesive layer having the following composition was coated on a 50 μm-thick transparent PET film and then dried, thereby forming a readily adhesive layer having a thickness of 3 μm. The readily adhesive layer had a surface Rz of 2.5 μm and a coefficient of static friction against the image receiving sheet of 0.4. Also, it had a rigid pendulum attenuation factor at 23° C. of 0.052.

Composition of Coating Liquid for Readily Adhesive Layer

| | | |
|---|---|---|
| Polyvinyl butyral (S-LEC BL1, | 5 | parts |
| manufactured by Sekisui Chemical Co., Ltd.) | | |
| Fluorine based surfactant (30% methyl ethyl | 0.3 | parts |
| ketone solution) (MEGAFAC F-780F, manufactured | | |
| by Dainippon Ink and Chemicals, Incorporated) | | |
| PMMA particle having a mean particle size of | 0.04 | parts |
| 5 μm (MX500, manufactured by Soken Chemical & | | |
| Engineering Co., Ltd.) | | |
| n-Propanol | 45 | parts |
| Methanol | 45 | parts |

### Example 2-5

In Example 2-1, the readily adhesive layer-provided transparent support was replaced by one as prepared by the following manner. Further, the resulting readily adhesive layer-provide transparent support onto which the image and the image receiving layer had been transferred was subjected to the following surface smoothening treatment.

Preparation of Readily Adhesive Layer-Provided Transparent Support

A hot-melt adhesive (HRODINE 7573, manufactured by Hirodine Corp.) was subjected to hot-melt extrusion in a thickness of 30 μm onto a 50 μm-thick transparent PET film, thereby forming a readily adhesive layer. Further, GLASSINE SEPA 70GS8 (release paper, manufactured by Oji Paper Co., Ltd.) was stuck on the readily adhesive layer by lamination. The release paper was peeled apart before re-transferring the image and the image receiving layer. The readily adhesive layer had a rigid pendulum attenuation factor at 23° C. of 0.055 and a rigid pendulum attenuation factor at 90° C. of 0.23. Also, the readily adhesive layer had a Vicat softening point of 60° C. Also, the readily adhesive layer had a surface Rz of 6.2 μm and a coefficient of static friction against the image receiving sheet of 0.7.

Surface Smoothening Treatment

The both sides of the above-obtained material in which the image and the image receiving layer had been transferred onto the readily adhesive layer-provided transparent support were sandwiched by a cover sheet (surface-treated polyester sheet having a surface Rz of 0.15 μm and a coefficient of static friction against the surface of the image receiving sheet of 0.27; CERAPEARL #100S, manufactured by Toyo Metallizing Co., Ltd.). Moreover, an aluminum plate having a thickness of 1 mm was superimposed in the lower side, and the resulting laminate was processed by a laminator (FL760T EXTRA, manufactured by Fuji Photo Film Co., Ltd.) (heating temperature: 125° C., pressurizing pressure: 4.5 N/cm) (FIG. 3C).

By the smoothening treatment, the glossiness of the surface of the image receiving layer in a non-image area (glossiness at a light receiving angle of 60° against the sample surface) changed from 30 to 100.

### Example 2-6

In Example 2-1, the thermal transfer sheet W was replaced by the metallically glossy thermal transfer sheet S.

### Referential Example 2-1

In Example 2-1, the readily adhesive layer-provided transparent support was replaced by a transparent support not provided with a readily adhesive layer (50 μm-thick transparent PET film).

### Referential Example 2-2

In Example 2-1, the readily adhesive layer-provided transparent support was replaced by HSL98W, manufactured by Teijin Limited. The readily adhesive layer had a surface Rz of 0.4 μm and a coefficient of static friction against the image receiving sheet of 1.1. Also, the readily adhesive layer had a rigid pendulum attenuation factor at 23° C. of 0.025.

### Referential Example 2-3

In Example 2-4, the mat particle (PMMA particle having a mean particle size of 5 μm) was not added to the readily adhesive layer. The readily adhesive layer had a thickness of 3 μm, a surface Rz of 0.16 μm, and a coefficient of static friction against the image receiving sheet of 1.2. Also, the readily adhesive layer had a rigid pendulum attenuation factor at 23° C. of 0.055.

### Referential Example 2-4

In Example 2-4, a mat particle (PMMA particle having a mean particle size of 10 μm) having a mean particle size of 10 μm was added to the readily adhesive layer. The readily adhesive layer had a thickness of 3 μm, a surface Rz of 8.0 μm, and a coefficient of static friction against the image receiving sheet of 0.3. Also, the readily adhesive layer had a rigid pendulum attenuation factor at 23° C. of 0.045.

Evaluation Methods and Evaluation Results

Each of the foregoing Examples and Comparative Examples was evaluated in the following manners. The results are shown in Table 2.

1. Adhesion strength of image and image receiving layer to transparent support:

The transparent support was folded ten times such that the image and the image receiving layer were positioned externally, and peeling of the image or image receiving layer was evaluated by visual observation.

A: Peeling was not generated.

B: Peeling was generated by folding 5 to 10 times.

C: Peeling was generated by folding 1 to 4 times.

2. Generation of wrinkle:

The image was confirmed and evaluated by visual observation and by using a loupe having a magnification of 50 times.

A: No problem occurred.

B: Uneven gloss was seen on the surface. The image did not change.

C: The image was warped in some portion.

TABLE 2

| | Readily adhesive layer | | | | |
|---|---|---|---|---|---|
| | Pendulum attenuation | Coefficient of static | Surface Rz | Evaluation result | |
| | factor | friction | (μm) | Adhesion strength | Wrinkle |
| Example 2-1 | 0.029 | 0.7 | 1.6 | A | A |
| Example 2-2 | 0.019 | 0.6 | 0.7 | B | A |
| Example 2-3 | 0.021 | 0.5 | 1.7 | A | A |
| Example 2-4 | 0.052 | 0.4 | 2.5 | A | A |
| Example 2-5 | 0.055 | 0.7 | 6.2 | A | A |
| Example 2-6 | 0.029 | 0.7 | 1.6 | A | A |
| Referential | — | — | — | C | C |
| Example 2-1 | | | | | |
| Referential | 0.025 | 1.1 | 0.4 | B | C |
| Example 2-2 | | | | | |
| Referential | 0.055 | 1.2 | 0.16 | A | C |
| Example 2-3 | | | | | |
| Referential | 0.045 | 0.3 | 8.0 | C | A |
| Example 2-4 | | | | | |

According to the invention, since a readily adhesive layer is previously provided on a support of a final medium to be transferred and an image is transferred onto the readily adhesive layer, the transferred image has good adhesion to the final medium to be transferred. Further, by performing a smoothening treatment, a glossy image having high image quality is obtained, and a non-image area of the final medium to be transferred, namely, the surface of an exposed portion where the image of the readily adhesive layer is not transferred, is smoothened, too and its transparency is enhanced. Also, by achieving the smoothening treatment by covering the final medium to be transferred by a cover sheet and heating them under pressure, the generation of a wrinkle is suppressed, whereby an image having good image quality can be obtained.

Further, According to the invention, by making the readily adhesive layer to be previously provided on the transparent support of the final medium to be transferred fall within a specified range, it is possible to obtain smooth contact between the final medium to be transferred and the intermediate transfer medium, thereby suppressing the generation of a wrinkle and the like in transferring the image. Accordingly, according to the invention, it is possible to obtain an image having high adhesion strength and free from uneven gloss and deformation on the transparent final medium to be transferred.

The entire disclosure of each and every foreign patent application from which the benefit of foreign priority has been claimed in the present application is incorporated herein by reference, as if fully set forth.

1. An image forming method comprises:
keeping a face of a final medium to be transferred towards a face of an intermediate transfer medium, wherein the final medium to be transferred comprises a transparent support having a readily adhesive layer, and the intermediate transfer medium has an image recorded on an image receiving layer;
transferring the image onto the readily adhesive layer, so as to form a transferred image; and
subjecting a surface of the readily adhesive layer having the transferred image to a smoothening treatment.

2. An image forming method comprises:
keeping a face of a final medium to be transferred towards a face of an intermediate transfer medium, wherein the final medium to be transferred comprises a transparent support having a readily adhesive layer, and the intermediate transfer medium has an image recorded on an image receiving layer;
transferring the image onto the readily adhesive layer, so as to form a laminate comprising the transparent support, the readily adhesive layer, the image and the image receiving layer, in this order; and
subjecting a surface of the laminate to a smoothening treatment.

3. The image forming method according to claim 1,
wherein the readily adhesive layer is formed by transferring a readily adhesive layer from a readily adhesive layer-provided release paper onto the transparent support.

4. The image forming method according to claim 1,
wherein the final medium to be transferred has a release sheet on the readily adhesive layer, and the method further comprises peeling apart the release sheet from the readily adhesive layer prior to the transferring the image.

5. The image forming method according to claim 3,
wherein the transferring a readily adhesive layer onto the transparent support is carried out by heating and pressurizing a laminate comprising the transparent support and the readily adhesive layer-provided release paper.

6. The image forming method according to claim 1,
wherein the readily adhesive layer has a surface roughness of from 0.5 to 10 μm in terms of Rz.

7. The image forming method according to claim 1,
wherein the readily adhesive layer has a surface roughness of from 0.5 to 7 μm in terms of Rz.

8. The image forming method according to claim 1,
wherein a coefficient of a static friction between the readily adhesive layer and a surface of the intermediate transfer medium is not more than 1.3.

9. The image forming method according to claim 1,
wherein a coefficient of a static friction between the readily adhesive layer and a surface of the intermediate transfer medium is not more than 0.8.

10. The image forming method according to claim 1,
wherein the readily adhesive layer has a rigid pendulum attenuation factor at 23° C. of 0.02 or more.

11. The image forming method according to claim 1,
wherein the readily adhesive layer has a rigid pendulum attenuation factor at 90° C. of 0.1 or more.

12. The image forming method according to claim 1,
wherein the readily adhesive layer comprises mat particles having a mean particle size of from 0.5 to 20 μm.

13. The image forming method according to claim 1,
wherein the readily adhesive layer comprises at least one of a polyvinyl butyral resin, a polyurethane resin and an acrylic resin.

14. The image forming method according to claim 1,
wherein the readily adhesive layer has a Vicat softening point of not higher than 100° C.

15. The image forming method according to claim 1,
wherein the transferring the image onto the readily adhesive layer is carried out by heating and pressurizing a laminate comprising the final medium to be transferred and the intermediate transfer medium.

16. The image forming method according to claim 1,
wherein the smoothening treatment is carried out by heating and pressurizing a laminate comprising the transparent support, the readily adhesive layer having the transferred image and a cover sheet on the surface of the readily adhesive layer having the transferred image.

17. The image forming method according to claim 16,
wherein a coefficient of a static friction between a surface of the cover sheet and a surface of an image receiving material is not more than 0.5.

18. The image forming method according to claim 16,
wherein the cover sheet has a surface roughness of from 0.1 to 3.0 μm in terms of Rz.

19. The image forming method according to claim 1,
wherein a glossiness of the surface of the readily adhesive layer having the transferred image is increased by from 5 to 100% by the smoothening treatment.

20. The image forming method according to claim 1,
wherein the image is an image containing at least a white color.

21. The image forming method according to claim 1,
wherein the image is an image containing at least a metallically glossy color.

22. The image forming method according to claim 1,
wherein an image recording on the image receiving layer of the intermediate transfer medium is a thermal transfer recording.

23. A final medium to be transferred for an image forming method comprises:
a transparent support; and
a readily adhesive layer provided on a surface of the transparent support onto which an image is to be transferred,
wherein the method comprises: keeping a face of the final medium to be transferred towards a face of an intermediate transfer medium having an image; and transferring the image onto the readily adhesive layer,
wherein the readily adhesive layer has a surface roughness of from 0.5 to 7 μm in terms of Rz.
